(19) United States
(12) Patent Application Publication
(10) Pub. No.: US 2023/0188271 A1
(43) Pub. Date: Jun. 15, 2023

(54) DATA COMMUNICATION APPARATUSES, METHODS FOR DATA COMMUNICATION, COMMUNICATION APPARATUSES AND METHODS FOR COMMUNICATION USING SHARED DATA

(71) Applicant: Fraunhofer-Gesellschaft zur Foerderung der angewandten Forschung e.V., Munich (DE)

(72) Inventors: Dietmar LIPKA, Erlangen (DE); Thomas HEYN, Erlangen (DE); Thomas SCHLICHTER, Erlangen (DE); Martin SPEITEL, Erlangen (DE); Matthias FREI, Erlangen (DE)

(21) Appl. No.: 18/164,529

(22) Filed: Feb. 3, 2023

Related U.S. Application Data
(63) Continuation of application No. PCT/EP2021/071815, filed on Aug. 4, 2021.

(30) Foreign Application Priority Data
Aug. 5, 2020 (EP) 20189711.3

(51) Int. Cl. H04L 1/1867; H04W 72/232; H04W 72/30

(52) U.S. Cl. CPC H04L 1/1887; H04L 1/1893; H04W 72/30; H04W 72/232; H04L 2001/0093

(57) ABSTRACT

Embodiments according to the first aspect of the invention comprise a data communication apparatus, e.g. a gNB or a base station, for transmitting unicast data to one or more other data communication apparatuses, e.g. to one or more UEs, and for transmitting shared data, e.g. multicast data or broadcast data, to a plurality of other data communication apparatuses, e.g. to a plurality of UEs, e.g. within a frame comprising a two-dimensional grid of transmission resource element positions. Furthermore, the data communication apparatus is configured to transmit unicast data and shared data using a common transmission resource element, e.g. OFDM (Orthogonal Frequency-Division Multiplexing) subcarrier or e.g. OFDM symbol, time-frequency grid, e.g. using a common subcarrier spacing and/or using a common slot length and/or using a common OFDM symbol length.

### CROSS REFERENCES TO RELATED APPLICATIONS

This application is a continuation of copending International Application No. PCT/EP2021/071815, filed Aug. 4, 2021, which is incorporated herein by reference in its entirety, and additionally claims priority from European Application No. EP 20 189 711.3, filed Aug. 5, 2020, which is incorporated herein by reference in its entirety.

Embodiments according to the invention are related to a data communication apparatus for transmitting unicast data to one or more other data communication apparatuses and for transmitting shared data to a plurality of other data communication apparatuses.

Further embodiments according to the invention are related to a data communication apparatus for transmitting shared data to a plurality of other data communication apparatuses.

Further embodiments according to the invention are related to a data communication apparatus for transmitting shared data to a plurality of other data communication apparatuses.

Further embodiments according to the invention are related to a communication system.

Further embodiments according to the invention are related to a data communication apparatus for receiving unicast data from one or more other data communication apparatuses and for receiving shared data from another data communication apparatus.

Further embodiments according to the invention are related to a data communication apparatus for receiving shared data from another data communication apparatuses.

Further embodiments according to the invention are related to a data communication apparatus.

Further embodiments according to the invention are related to methods for data communication.

Further embodiments according to the invention are related to methods for communication.

Further embodiments according to the invention create a computer program for performing one of said methods.

Further embodiments according to the invention related to 5G NR multicast and broadcast. Further embodiments are related to data communication apparatuses, communication systems, methods and computer programs for 5G NR multicast and broadcast.

### BACKGROUND OF THE INVENTION

No broadcast/multicast feature support is specified in the first two NR releases of 3GPP, i.e. Rel-15 and Rel-16. Nevertheless, there can, for example, be important use cases for which broadcast and/or multicast could provide substantial improvements, for example regarding system efficiency and/or user experience. However, the implementation of such features should only have limited impact on the user equipment, for example in order to be able to operate at low costs. Another requirement may be a good flexibility, in order to allow for an adaptive resource allocation. Resources of a cell may have to be distributed according to the content requests of its users in real time, with low effort.

Therefore, it is desired to get a concept which provides a better compromise between complexity, implementation impact, for example especially on the user equipment, flexibility, for example the ability to switch between casting modes fast and with low effort, and data transmission efficiency, for example good latency, high data rate and low overhead.

This is achieved by the subject matter of the independent claims of the present application.

Further embodiments according to the invention are defined by the subject matter of the dependent claims of the present application.

### SUMMARY

An embodiment may have a data communication apparatus for transmitting unicast data to one or more other data communication apparatuses and for transmitting shared data to a plurality of other data communication apparatuses, wherein the data communication apparatus is configured to transmit unicast data and shared data using a common transmission resource element time-frequency grid; and wherein the data communication apparatus is configured to inform one or more other data communication apparatuses about an assignment of one or more dedicated identifiers associated with shared data during a connection establishment.

Another embodiment may have a method for data communication, the method comprising: transmitting unicast data to one or more data communication apparatuses; and transmitting shared data to a plurality of data communication apparatuses; and wherein the unicast data and the shared data are transmitted using a common transmission resource element time-frequency grid; and informing one or more other data communication apparatuses about an assignment of one or more dedicated identifiers associated with shared data during a connection establishment.

Another embodiment may have a method for data communication, the method comprising: receiving unicast data from at least one data communication apparatuses; and/or receiving shared data from the same or another data communication apparatus; and wherein the unicast data and shared data are received using a common transmission resource element time-frequency grid; and receiving and/or evaluating an information about an assignment of one or more dedicated identifiers associated with shared data during a connection establishment.

Another embodiment may have a computer program for performing the inventive methods when the computer program runs on a computer.

### SUMMARY OF THE INVENTION ACCORDING TO THE FIRST ASPECT OF THE INVENTION

Embodiments according to the first aspect of the invention comprise a data communication apparatus, e.g. a gNB or a base station, for transmitting unicast data to one or more other data communication apparatuses, e.g. to one or more UEs, and for transmitting shared data, e.g. multicast data or broadcast data, to a plurality of other data communication apparatuses, e.g. to a plurality of UEs, e.g. within a frame comprising a two-dimensional grid of transmission resource element positions. Furthermore, the data communication apparatus is configured to transmit unicast data and shared data using a common transmission resource element, e.g. OFDM (Orthogonal Frequency-Division Multiplexing) subcarrier or e.g. OFDM symbol, time-frequency grid, e.g. using a common subcarrier spacing and/or using a common slot length and/or using a common OFDM symbol length.

Embodiments according to the first aspect of the invention are based on the idea to transmit unicast data and shared data, for example multicast data or broadcast data, using a common transmission resource element time-frequency grid.

The shared data may be multicast data or broadcast data and may hence be transmitted to a plurality of other data communication apparatuses, for example user equipments (UEs) The inventors recognized that the unicast data and the shared data may be transmitted using a common transmission resource element time-frequency grid. In simple words and as an example, the transmission resource element time-frequency grid may, for example, be a time-frequency grid of an OFDM comprising a plurality of subcarriers with distinct subcarrier spacings. Unicast and broadcast data may be transmitted within the same grid, for example on same OFDM symbols with common subcarrier spacings and/or common OFDM symbol lengths or on different OFDM symbols but with different subcarrier spacings and/or different OFDM symbol lengths or on same OFDM symbols with different subcarrier spacings and/or different OFDM symbol lengths but separated sufficiently in the frequency domain. The inventors recognized that such a joint transmission may be performed efficiently.

In addition, the transmission of shared data may be integrated with low effort and complexity in an existing unicast transmission architecture. Hence, concepts according to the invention may allow for a low cost and easy to implement extension of communication protocols.

Moreover, it has been found that a signaling overhead, which may be used for signaling which transmission resource elements of the common transmission resource element time-frequency grid are used for unicast data and which are used for shared data, is not excessive, such that the usage of the common transmission resource element time-frequency grid provides for a good compromise between implementation effort, flexibility and resource efficiency.

Moreover, it has been recognized that the usage of a common transmission resource element time-frequency grid for unicast data and for shared data allows for a double-usage of transmission resource elements for unicast data and for shared data, depending on a current demand. In other words, the usage of a common transmission resource element time-frequency grid allows to allocate (e.g. using a resource allocation of the data communication apparatus) a given transmission resource element (e.g. a certain symbol position relative to a border of a frame) alternatively for a transmission of unicast data or for a transmission of shared data. Consequently, it is, for example, possible to adjust a number of transmission resource elements available for unicast data and for a number of transmission resource elements available for shared data in dependence on the current demand for the two different types of transmission (unicast vs. shared or multicast).

In addition, the usage of a common resource element time-frequency grid for unicast data and for shared data allows for a simplified transmission and reception of both unicast data and shared data when compared to concepts in which separate resource element time-frequency grids are used. For example, a common transmitter structure or receiver structure can be used for unicast data and shared data, which may, for example, use a same frequency spacing and/or a same number of frequency bins. Also, reference symbols (e.g. pilot symbols) may, for example, be shared between unicast data and shared data (such that, for example, the same reference symbol may be evaluated both for the reception of unicast data and for the reception of shared data).

To conclude, the usage of the common transmission resource element time-frequency grid provides for a good compromise between implementation effort, flexibility and resource efficiency.

According to further embodiments according to the first aspect of the invention, the data communication apparatus is configured to transmit a scheduling information via a control channel.

The scheduling information may, for example, describe which transmission resource element positions of the common transmission resource element time-frequency grid are used for a transmission of unicast data and which transmission resource element positions of the common transmission resource element time-frequency grid are used for a transmission of shared data.

A resource element, for example a transmission resource element, may, for example, be represented by a subcarrier of an OFDM symbol. As an example, an OFDM may span the whole carrier bandwidth. A resource element may for example, be designated with RE. An RE may, for example, be represented by one subcarrier in one OFDM symbol. The RE may be one subcarrier in frequency domain and one OFDM symbol in time domain. 12 REs may, for example, constitute a “resource block” abbreviated as RB. A PDCCH (physical downlink control channel) in NR may, for example, contain a Frequency domain resource assignment with granularity of RBs and a time domain resource assignment.

The control channel may, for example be a common control channel for signaling both transmission resources for the transmission of unicast data and transmission resources for the transmission of shared data. The control channel may, for example, be a “PDCCH” control channel, e.g. a physical downlink control channel.

In addition, the scheduling information may, for example, be transmitted with a suitable downlink format, e.g. DCI (Downlink control information) format.

Transmission of the scheduling information via the control channel may allow for a coordination of unicast data and shared data on the common transmission resource element time-frequency grid with low effort and low complexity, for exampling using a PDCCH control channel. Hence, a resource element may, for example, sometimes be used for unicast data and for shared data. Allocation of unicast data or shared data to a resource element may be performed dynamically. Therefore, bitrates available for unicast data and shared data may be adjusted dynamically.

According to further embodiments according to the first aspect of the invention, the data communication apparatus is configured to signal transmission resources used for the transmission of shared data, e.g. in the form of a scheduling information, using one or more dedicated identifiers, e.g. using one or more dedicated “radio network temporary identifiers and/or e.g. using one or more dedicated multicast radio network temporary identifiers MC-RNTI or using one or more dedicated broadcast radio network temporary identifiers BC-RNTI.

As an example, a plurality or even all user equipments (UE) capable of multicast may obtain the same dedicated identifier, e.g. MC-RNTI. Hence, the UEs may receive and decode a multicast data stream using the dedicated identifier. The UEs may receive and decode the same multicast data stream using the dedicated identifier. For multicast, one or multiple identifiers may, for example, be assigned. Usage of multiple identifiers may allow for a separation of UEs into groups. As an example, individual identifiers may be assigned to individual groups of devices. Hence multicasting may be performed efficiently. This may be beneficial for network slicing. Different identifiers may be used for groups of UEs or devices with different requirements, e.g. a first group requiring a low latency and moderate data rate and a second group with moderate latency, and high data rate.

Furthermore, the identifiers, for example the identifiers for multicast, e.g. the MC-RNTI may be assigned in a procedure, such as random access, system information and/or dedicated RRC (radio resource control) signaling.

For broadcasting, assignment of an identifier may, for example, not be performed, since a fixed identifier, for example similar to SI-RNTI and P-RNTI, may be used.

Therefore, usage and signaling of transmission resources may allow for efficient multicast and/or broadcast transmissions.

To conclude, for example, by signaling the transmission resources used for a shared transmission using dedicated identifiers, it is possible to efficiently define which UE should receive which data (e.g. which UE should receive shared data and which UE should not receive shared data).

According to further embodiments according to the first aspect of the invention, the data communication apparatus is configured to signal transmission resources used for the transmission of unicast data using one or more unicast identifiers, e.g. using one or more “radio network temporary identifiers” RNTI, e.g. using the same control channel (e.g. PDCCH) used for the signaling of transmission resources used for a transmission of shared data.

As an example, concepts according to embodiments may comprise usage of a unicast interface for multicast and/or broadcast. This may allow additional usage of multicast and/or broadcast functionality with limited additional complexity and/or effort. A common control channel, e.g. PDCCH, may be used for controlling the transmission of unicast data and shared data.

According to further embodiments according to the first aspect of the invention, the data communication apparatus is configured to generate a scrambling sequence for a scrambling of a control information, e.g. control information transmitted via the PDCCH, comprising the scheduling information, which may, for example, describe which transmission resource element positions of the common transmission resource element time-frequency grid are used for a transmission of unicast data and which transmission resource element positions of the common transmission resource element time-frequency grid are used for a transmission of shared data, using, or, for example, on basis of, a respective dedicated identifier.

The data communication apparatus may, for example, comprise a linear-feedback shift register in order to provide the scrambling sequence, e.g. to scramble the control information. The data communication apparatus may, for example, scramble, e.g. adapt, the control information based on a characterization of a respective channel for the transmission of the control information. Scrambling may be performed based on predefined tables. The data communication apparatus may, for example, be configured to adapt an order of sequences of the control information, for example in order to allow for a better transmission of the control information. This may improve efficiency of data transmission.

According to further embodiments according to the first aspect of the invention, the data communication apparatus is configured to generate a scrambling sequence for a scrambling of shared data, e.g. shared data transmitted in the PDSCH, using, or, for example on basis of, a respective dedicated identifier.

Scrambling of the shared data may, for example, be performed as explained before in the context of the control information. Hence, transmission efficiency of the shared data may be improved.

According to further embodiments according to the first aspect of the invention, the data communication apparatus is configured to dynamically signal, whether transmission resources of a slot are associated with a transmission of shared data or with a transmission of unicast data or both in parallel, for example such that the data communication device can decide, with a very fine (e.g. temporal) granularity, whether to transmit shared data or unicast data or both.

As an example, a transmission of unicast data and multicast data, unicast data and broadcast data, only unicast data, only multicast data, only broadcast data and/or multicast and broadcast data may be performed. Any combination of data may be transmitted in parallel. One benefit of parallel unicast may be that it can be used for signaling and control.

As an example, the unicast channel may have a low bandwidth. The unicast channel may, for example, be used for request and/or release of broadcast/multicast and/or to ask for desired service.

Hence, dynamic changes between unicast, broadcast and multicast can, for example, be included and/or service continuity can be maintained. Integration and/or coexistence of UEs, e.g. capable of unicast and/or multicast and/or broadcast and receive-only devices (IoT TV, radio) can be seamless.

According to further embodiments according to the first aspect of the invention, the data communication apparatus is configured to signal, on a per-slot-basis, wherein a slot may, for example, comprise 14 OFDM symbols, whether transmission resources of a slot are associated with a transmission of shared data or with a transmission of unicast data or both in parallel, for example such that the data communication device can decide, with a very fine (e.g. temporal) granularity, whether to transmit shared data or unicast data or both.

The signaling on the per-slot-basis may allow for a highly flexible allocation of shared data and/or unicast data. Hence, adaptation may be performed for individual slots, allowing for an adaptation of the data transmission with respect to highly individual UE requirements.

According to further embodiments according to the first aspect of the invention, the data communication apparatus is configured to signal transmission resources for the transmission of the shared data, e.g. in the form of an information which describes which transmission resource element positions of the common transmission resource element time-frequency grid are for a transmission of shared data, in a semi-persistent manner, e.g. with a limited validity time of a signal transmission resource allocation which is larger than a slot.

According to further embodiments according to the first aspect of the invention, the data communication apparatus is configured to signal transmission resources for the transmission of the shared data, e.g. in the form of an information which describes which transmission resource element positions of the common transmission resource element time-frequency grid are for a transmission of shared data, in a semi-static manner, e.g. with a time granularity which is larger than a slot.

Hence, as an example, the data communication apparatus may be configured to transmit the shared data in a semi-persistent manner and/or in a semi-static manner. In addition, the data communication apparatus may, for example, be configured to transmit the shared data in a dynamic manner. In other words, the data communication apparatus may be configured to support one or more of the following scheduling modes: dynamic, semi-persistent and/or semi-static.

Dynamic scheduling may, for example, be flexible and applied where fast adaption is needed to minimize or reduce the impact on other traffic and/or for optimization of the cell capacity. On the other hand, a higher signaling load on a control channel, e.g. PDCCH might have to be accepted. In order to allow to reduce the signaling load on the control channel, e.g. PDCCH, semi-persistent scheduling may be applied. In simple words, as an example, resource allocation may be fixed for certain time intervals. This may allow for a good comprise between flexibility and complexity, e.g. as a compromise between dynamic scheduling or allocation and static approaches.

According to further embodiments according to the first aspect of the invention, the data communication apparatus is configured to signal transmission resources for the transmission of the shared data, e.g. in the form of an information which describes which transmission resource element positions of the common transmission resource element time-frequency grid are for a transmission of shared data, in a configuration information, e.g. in one or more system information blocks, e.g. in a configuration information which is only transmitted once per multiple slots, or which is transmitted irregularly, or which is transmitted using a plurality of message blocks, or which becomes effective only with a delay of one or more slots.

As an example, information about the transmission resources for the transmission of the shared data may be aggregated in the configuration information, hence allowing for reduced signaling. Transmission of such information may, for example, be performed in certain time intervals, hence reducing overhead. Therefore, as an example, the control information transmitted may be valid for a certain time span, before being updated with a newly transmitted control information. As an example, transmission of the control information may be performed via broadcast,

According to further embodiments according to the first aspect of the invention, the data communication apparatus is configured to signal transmission resources for the transmission of the shared data, e.g. in the form of an information which describes which transmission resource element positions of the common transmission resource element time-frequency grid are for a transmission of shared data, in radio resource control message, e.g. a RRC message, which is directed to a single other data communication apparatus.

In other words and as an example, solutions to signal multicast/broadcast reservations according to embodiments are, for example, the system information or RRC signaling. However, signaling via the system information may be efficient, e.g. since RRC signaling can be dedicated to a UE.

According to further embodiments according to the first aspect of the invention, the data communication apparatus is configured to schedule signal transmission resources for the transmission of the shared data, e.g. in the form of an information which describes which transmission resource element positions of the common transmission resource element time-frequency grid are for a transmission of shared data, to be time-multiplexed and/or frequency multiplexed with signal transmission resources for the transmission of unicast data, e.g. to have a time multiplex of PDSCH (e.g. unicast data) and PMCH (e.g. multicast data) slots in a bandwidth in the same bandwidth part, or, as an example, to have a frequency multiplex by assigning separate bandwidth parts for the transmission of the shared data and of the unicast data, or, as an example, to have a combination of frequency and time multiplex by mapping PDSCH (e.g. unicast data) and PMCH (e.g. multicast data) on the same bandwidth part, and optionally combining a semi-static reservation of resource blocks in the frequency domain with a time multiplex pattern (e.g. such that unicast data and multicast data are alternatingly transmitted in a common frequency range). As an example, a time multiplex of PDSCH and/or PMCH (e.g. physical multicast channel) slots e.g. in a bandwidth in the same bandwidth part, e.g. by a semi-static time multiplex pattern, may be performed. This option can for example allow to configure slots with PDSCH only and/or PMCH only. Furthermore, a frequency multiplex by assigning separate bandwidth parts may optionally be performed. One bandwidth part may, for example be PDSCH only, the other PMCH only. Moreover, a combination of frequency and time multiplex by mapping PDSCH and/or PMCH on the same bandwidth part and/or combining a semi-static reservation of resource blocks, e.g. in the frequency domain for example with a time multiplex pattern may be performed. This option can for example allow to configure slots with PDSCH only, PMCH only and slots with both. However, it is to be noted that any combination of the above mentioned may be performed.

According to further embodiments according to the first aspect of the invention, the data communication apparatus is configured to transmit a configuration information, e.g. one or more system information blocks, indicating one or more dedicated identifiers, e.g. MC_RNTIs and/or BC-RNTIs, associated with shared data.

The configuration information may be transmitted as a broadcast. The benefit of using system information, as an example of the configuration information, can for example be that it can be efficient, since it can for example be itself a broadcast signaling channel.

According to further embodiments according to the first aspect of the invention, the data communication apparatus is configured to transmit the configuration information such that the configuration information describes one or more service characteristics, e.g. a type of service, like software update data, audio data, video data, text message data, or the like and/or a Quality of service information, of the shared data, e.g. in the form of an association between a dedicated identifier (e.g. MC-RNTI) and one or more associated service characteristics (e.g. a service type identifier and/or a quality of service identifier), e.g. in the form of a list of one or more MC-RNTIs and associated additional information.

With knowledge of individual service characteristics, features of a data communication between data communication apparatus and UE may be adapted, in order to improve communication efficiency. An adaptation may, for example, be performed with respect to latency or data rates.

According to further embodiments according to the first aspect of the invention, the data communication apparatus is configured to inform one or more other data communication apparatuses about an assignment of one or more dedicated identifiers, e.g. MC_RNTIs (e.g. Multicast Radio Network Temporary Identifier) and/or BC-RNTIs (e.g. Broadcast Radio Network Temporary Identifier), associated with shared data using a random access procedure or using a dedicated radio resource control, e.g. RRC, signaling, which may, for example, be directed individually to the one or more other data communication apparatuses.

The one or more dedicated identifiers may, for example, be taken from reserved or unused values. As an example, informing about the assignment may be performed via configuration information, e.g. system information, for example as explained above, a random access procedure and/or a dedicated RRC signaling. Hence, embodiments according to the invention comprise a good flexibility with regard to providing assignment information. This may allow for a selection according to a specific application.

According to further embodiments according to the first aspect of the invention, the data communication apparatus is configured to inform one or more other data communication apparatuses about an assignment of one or more dedicated identifiers, e.g. MC-RNTIs and/or BC-RNTIs, associated with shared data during a connection establishment, e.g. together with an assignment of a cell radio network temporary identifier, e.g. using a random access procedure, e.g. via or using a 5G Initial access or 5G RACH process.

Hence, information about the assignment may, for example, be available in a respective UE, directly after connection establishment. This may allow for an immediate, and/or fast, start of user data transfer, consequently improving communication efficiency.

Although, multicast can for example be distinguished from broadcast that might need a registration on the network, it could for example also allow to collect the dedicated identifiers, e.g. MC-RNTIs, and/or additional information, e.g. already in IDLE mode for example before and/or or even without registration.

According to further embodiments according to the first aspect of the invention, the data communication apparatus is configured to map multicast data onto a physical downlink shared channel, e.g. PDSCH, and to schedule the transmission of the multicast data using a physical downlink control channel, e.g. PDCCH.

According to further embodiments according to the first aspect of the invention, the data communication apparatus is configured to map broadcast data onto a physical downlink shared channel, e.g. PDSCH, and to schedule the transmission of the broadcast data using a physical downlink control channel, e.g. PDCCH.

According to further embodiments according to the first aspect of the invention, the data communication apparatus is configured to map uncast data, e.g. unicast data, onto the physical downlink shared channel, e.g. PDSCH, and to schedule the transmission of the unicast data using the physical downlink control channel, e.g. PDCCH.

The inventors recognized that multicast, broadcast and or unicast data may be mapped on the same physical downlink shared channel and scheduling of the respective data may be performed using the same physical downlink control channel. Hence, an impact on UE and existing structure of the communication topology, e.g. the physical layer may be limited. Therefore, multicast, broadcast and/or unicast may be provided in any combination, e.g. in parallel, with low complexity and without usage of additional communication channels.

According to further embodiments according to the first aspect of the invention, the data communication apparatus is configured to use a same scheduling format, e.g. a same type of downlink control information included into the PDCCH, just with different radio network temporary identifiers, for the scheduling of shared data, e.g. multicast data or broadcast data, and for the scheduling of unicast data.

As explained above, the inventors recognized that a common scheduling format may be used for providing shared data and/or unicast data, hence allowing for a system with low complexity but improved functionality.

According to further embodiments according to the first aspect of the invention, the data communication apparatus is configured to establish one or more unicast transmissions with another data communication apparatus to communicate, e.g. transmit or receive, additional information for accessing the shared data, e.g. a key for an encryption of multicast or broadcast data, or side device-specific side information regarding the shared data, and/or for controlling the transmission of the shared data, e.g. for confirming receipt or for requesting a retransmission, or for adapting the provision of the shared data.

Hence, unicast transmissions, and shared data transmission may be used synergistically. Separation and/or division of shared data, e.g. in user data transmitted via a shared data transmission, e.g. multicast or broadcast transmission and in meta data and/or access data, e.g. encryption data, for example for accessing the user data, may improve communication efficiency and information security.

According to further embodiments according to the first aspect of the invention, the data communication apparatus is configured to transmit the unicast data and the shared data in parallel. This may allow for increased data transmission rates and low latency communication.

According to further embodiments according to the first aspect of the invention, the unicast data, which may, for example, be associated to the shared data, is adapted for a signaling and/or a control of a processing, e.g. decryption, of the shared data.

As explained above, unicast data and shared data may be used synergistically. As an example, unicast data comprising a control or processing information may be dedicated to and transmitted to specific UEs, allowing to access, or to control or to process shared data. This may allow for a secure and efficient communication.

According to further embodiments according to the first aspect of the invention, a data rate of unicast data is smaller, e.g. at least by a factor of 2, or at least by a factor of 5 or at least by a factor of 10, than a data rate of the shared data to which the unicast data is associated.

Providing a bigger data rate for the shared data transmission, may allow for a better distribution of available bandwidth. For example, in case a plurality of UEs request a common content, resources may be advantageously provided for said content, instead of a usage for single UEs requiring individual content.

According to further embodiments according to the first aspect of the invention, the data communication apparatus is configured to dynamically change an allocation of transmission resource element positions of the common transmission resource element time-frequency grid, e.g. OFDM symbol and resource block, to, or for example of, shared data and unicast data, e.g. on a slot-by-slot basis, e.g. in accordance with a variation of a data rate of the shared data, which may, for example, be variable bitrate video and/or audio coding, e.g. using a RNTI-based allocation information, wherein different RNTIs are used for unicast data transmission and shared data transmission.

The method of dynamic scheduling with RNTI addressing may for example comprise the advantage of a good adaptation to variable bitrate services, for example variable bitrate (VBR) video and/or audio coding. In some examples, even “static” media bit rates do not necessarily hit a single constant value. Corresponding channel capacities can for example be adjusted as needed, e.g. so that channel capacity can be optimally shared and/or exploited with other services e.g. like unicast. Freed capacity can for example be used and marketed for other services. Examples comprise “discount traffic”, application with uncritical delay demands like over-the-air (OTA) updates, infotainment updates, news, weather, stock market, etc. This approach can for example minimize or reduce the waste of resources and at the same time for example increase the efficiency of resource allocation.

According to further embodiments according to the first aspect of the invention, the data communication apparatus is configured to map allocations, e.g. grants conveyed in PDCCH, of transmission resource element positions in the transmission resource element time-frequency grid, e.g. OFDM symbol and resource block, to coresets, such that allocations of transmission resource element positions for a transmission of shared data and allocations of transmission resource element positions of unicast data are mapped into the same corset, or such that allocations of transmission resource element positions for a transmission of shared data and allocations of transmission resource element positions of unicast data are mapped into different coresets.

A coreset may, for example, be a set of physical resources (e.g. an area in a common transmission element time-frequency grid) and a set of parameters that may, for example, provide or carry PDCCH/DCI. Embodiments according to the invention provide a good flexibility, for example allowing to adjust or choose the mapping of allocations of transmission resource element positions in the transmission resource element time-frequency grid to coresets adaptively.

According to further embodiments according to the first aspect of the invention, the data communication apparatus is configured to map allocations, e.g. grants conveyed in PDCCH, of transmission resource element positions in the transmission resource element time-frequency grid, e.g. OFDM symbol and resource blocks, for a transmission of shared data to a corset comprising a system information scheduling, e.g. coreset 0.

The coreset comprising the system information scheduling may, for example, be a logical choice, since it may contain the PDCCHs for system information, which might closely resemble multicast. Hence, additional functionality may be incorporated in an existing framework without a significant increase in complexity.

According to further embodiments according to the first aspect of the invention, the data communication apparatus is configured to transmit the shared data using multicast transmission resources or using broadcast transmission resources, which are, for example, signaled to be granted for a multicast transmission or for a broadcast transmission Furthermore, the data communication apparatus is configured to retransmit the shared data, or a part of the shared data, using multicast transmission resources or using broadcast transmission resources in response to a detection of a transmission problem, e.g. in response to a retransmission request from one or more other data communication apparatuses (e.g. a “nack” signaling), or in response to a nonappearance of a confirmation-of-receipt message from one or more other data communication devices.

Retransmission of shared data may improve communication efficiency. As an example, some services may require robust channel coding, for example with a low code rate, and for example with the receiving device waiting for repetitions. Embodiments according to the invention may allow for a better data rate, for example without an unnecessarily high latency. As an example, a shared data cast may be associated with a low rate unicast channel whose uplink is used to send ACK/NACKs. Therefore, retransmission may be performed, on all entities which are also responsible for unicast retransmission, e.g. PDCP, RLC and/or HARQ. The unicast channel may require only low capacity being used for multicast control only. Bandwidth adaptation may, for example, be applied to multicast only, and therefore scheduling may be facilitated, keeping the benefit of a one-to-many link. As an example, even if some UEs need a retransmission, and more of the UEs do not, channel capacity can be efficiently used.

According to further embodiments according to the first aspect of the invention, the data communication apparatus is configured to adapt a beamforming, which may, for example, be achieved using a simultaneous transmission of a plurality of radio frequency signals via a plurality of antennas, wherein the radio frequency signals may, for example, comprise different amplitudes and/or may be phase shifted with respect to each other, in order to perform the beam forming, to a simultaneous transmission of the shared data to the plurality of other data communication apparatuses.

Therefore, a signal quality at UEs may be improved. Hence, communication efficiency, for example, based on a lower amount of transmission errors may be achieved. As an example, 2-layer MIMO, e.g. without PMI feedback can for example be supported, e.g. since the layer to antenna port mapping can for example correspond to a unity precoding matrix which can be optimal or advantageous for cross-polarized antennas.

In the following further embodiments according to the first aspect of the invention are discussed. The following embodiments may, for example, comprise or may be used as counterpart to the before mentioned data communication apparatus. Hence, as an example, transmitting unicast data to one or more other data communication apparatuses may correspond to receiving unicast data from one or more other data communication apparatuses, a transmission of unicast data and shared data using a common transmission resource element may correspond to a receiving of unicast data and shared data using a common transmission resource element, receiving and/or evaluating of a signal or information may correspond to informing and/or transmitting of said signal or information and extracting an information may correspond to mapping said information and vice versa.

Analogously a base station, for example as an example of a data communication apparatus, configured to transmit a signaling or data may correspond to a user equipment, as an example of a data communication apparatus, configured to receive said signaling or data and vice versa.

Therefore, the features, functionalities and advantages explained above are to be understood in a similar, or corresponding or analogous manner. Accordingly, any of the features, functionalities and details discussed herein above can optionally be used in (e.g. in an identical or analogous manner) in a data communication apparatus as explained in the following and vice versa, both individually and taken in combination.

Further embodiments according to the first aspect of the invention comprise a data communication apparatus, e.g. a UE, for receiving unicast data from one or more other data communication apparatuses, e.g. from one or more base stations, and for receiving shared data, e.g. multicast data or broadcast data, from another data communication apparatus, e.g. from a base station, e.g. gNB, e.g. within a frame comprising a two-dimensional grid of transmission resource element positions. Furthermore, the data communication apparatus is configured to receive unicast data and shared data using a common transmission resource element, e.g. OFDM subcarrier or e.g. OFDM symbol, time-frequency grid, e.g. OFDM symbol and resource block, e.g. using a common subcarrier spacing and/or using a common slot length and/or using a common OFDM symbol length.

Accordingly, an evaluation of both shared data and unicast data is possible using a simple receiver structure, which does not need to be adapted to separate (two-dimensional) grids of transmission resource element positions. Accordingly, a power consumption at the side of the receiver can be held reasonably low. Moreover, the receiver can, for example, rapidly adapt to a variation of data rates of the shared data and of the unicast data. Moreover, the same pilot symbols may be used by the receiver for the reception of shared data and unicast data. which also contributed to a good resource efficiency. To conclude, the above discussed concept provides for a good tradeoff between implementation complexity, data rate and resource efficiency.

According to further embodiments according to the first aspect of the invention, the data communication apparatus is configured to receive a scheduling information via a control channel.

The scheduling information may, for example, describe which transmission resource element positions of the common transmission resource element time-frequency grid are used for a transmission of unicast data and which transmission resource element positions of the common transmission resource element time-frequency grid are used for a transmission of shared data.

The resource element, e.g. transmission resource element, may, for example, be represented by a subcarrier of an OFDM symbol. As an example, an OFDM may span the whole carrier bandwidth. A resource element may, for example, be designated with RE. An RE may, for example, be represented by one subcarrier in one OFDM symbol. 12 REs may, for example, constitute a “resource block” abbreviated as RB. A PDCCH in NR may, for example, contain a Frequency domain resource assignment with granularity of RBs and a Time domain resource assignment

The control channel may, for example, be a common control channel for signaling both transmission resources for the transmission of unicast data and transmission resources for the transmission of shared data, e.g. a “PDCCH” control channel.

According to further embodiments according to the first aspect of the invention, the data communication apparatus is configured to receive and/or evaluate a signaling of transmission resources used for the transmission of shared data, e.g. in the form of a scheduling information, using one or more dedicated identifiers, e.g. using one or more dedicated “radio network temporary identifiers”; e.g. using one or more dedicated multicast radio network temporary identifiers MC-RNTI or using one or more dedicated broadcast radio network temporary identifiers BC-RNTI.

According to further embodiments according to the first aspect of the invention, the data communication apparatus is configured to receive and/or evaluate a signaling of transmission resources used for the transmission of unicast data using one or more unicast identifiers, e.g. using one or more “radio network temporary identifiers” RNTI, e.g. using the same control channel (e.g. PDCCH) used for the signaling of transmission resources used for a transmission of shared data.

According to further embodiments according to the first aspect of the invention, the data communication apparatus is configured to generate a descrambling sequence for a descrambling of a control information, e.g. control information transmitted via the PDCCH, comprising the scheduling information, which may for example, describe which transmission resource element positions of the common transmission resource element time-frequency grid are used for a transmission of unicast data and which transmission resource element positions of the common transmission resource element time-frequency grid are used for a transmission of shared data, using, or, for example, on the basis of, a respective dedicated identifier.

According to further embodiments according to the first aspect of the invention, the data communication apparatus is configured to generate a descrambling sequence for a descrambling of shared data, e.g. shared data transmitted in the PDSCH, using, or for example on the basis of, a respective dedicated identifier.

According to further embodiments according to the first aspect of the invention, the data communication apparatus is configured to receive and/or evaluate, e.g. when extracting data, a dynamic signaling, whether transmission resources of a slot are associated with a transmission, or for example reception, of shared data or with a transmission, or for example reception, of unicast data or both in parallel, for example, such that the data communication device can decide, with a very fine (e.g. temporal) granularity, whether (or where) to extract shared data or unicast data or both.

According to further embodiments according to the first aspect of the invention, the data communication apparatus is configured to receive and/or evaluate, e.g. when extracting data, a signaling, on a per-slot-basis, wherein a slot may, for example comprise 14 OFDM symbols, whether transmission resources of a slot are associated with a transmission, or for example reception, of shared data or with a transmission, or for example reception, of unicast data or both in parallel, for example, such that a the data communication device can decide, with a very fine (e.g. temporal) granularity, whether (or from where) to extract shared data or unicast data or both.

According to further embodiments according to the first aspect of the invention, the data communication apparatus is configured to receive and/or evaluate, e.g. when extracting data, a semi-persistent signaling of transmission resources for the transmission, or for example reception, of the shared data, e.g. in the form of an information which describes which transmission resource element positions of the common transmission resource element time-frequency grid are for a transmission (or extraction) of shared data, e.g. a signaling with a limited validity time of a signal transmission resource allocation which is larger than a slot.

According to further embodiments according to the first aspect of the invention, the data communication apparatus is configured to receive and/or evaluate, e.g. when extracting data, a semi-static signaling of transmission resources for the transmission, or for example reception, of the shared data, e.g. in the form of an information which describes which transmission resource element positions of the common transmission resource element time-frequency grid are for a transmission (or extraction) of shared data, e.g. with a time granularity which is larger than a slot.

According to further embodiments according to the first aspect of the invention, the data communication apparatus is configured to receive and/or evaluate, e.g. when extracting data, a signaling of transmission resources for the transmission, or for example reception, of the shared data, e.g. in the form of an information which describes which transmission resource element positions of the common transmission resource element time-frequency grid are for a transmission (or reception) of shared data, in a configuration information, e.g. in one or more system information blocks, e.g. in a configuration information which is only transmitted once per multiple slots, or which is transmitted irregularly, or which is transmitted using a plurality of message blocks, or which becomes effective only with a delay of one or more slots.

According to further embodiments according to the first aspect of the invention, the data communication apparatus is configured to receive and/or evaluate, e.g. when extracting data, a signaling of transmission resources for the transmission, or for example reception, of the shared data, e.g. in the form of an information which describes which transmission resource element positions of the common transmission resource element time-frequency grid are for a transmission (or extraction) of shared data, in a radio resource control message, e.g. a RRC message, which is individually directed to the data communication apparatus.

According to further embodiments according to the first aspect of the invention, the data communication apparatus is configured to receive and/or evaluate a scheduling information, e.g. in the form of an information which describes which transmission resource element positions of the common transmission resource element time-frequency grid are for a transmission (or reception, or extraction) of shared data, in order to extract the shared data which are time-multiplexed and/or frequency multiplexed with signal transmission resources for the transmission of unicast data, e.g. to extract the shared data from a time multiplex of PDSCH (e.g. unicast data) and PMCH (e.g. multicast data) slots in a bandwidth in the same bandwidth part, or, as an example, to extract the shared data from a frequency multiplex in which separate bandwidth parts are assigned for the transmission of the shared data and of the unicast data, or, as an example, to extract the shared data from a combination of frequency and time multiplex in which PDSCH (e.g. unicast data) and PMCH (e.g. multicast data) are mapped on the same bandwidth part, and in which optionally a semi-static reservation of resource blocks in the frequency domain is combined with a time multiplex pattern (e.g. such that unicast data and multicast data are alternatingly transmitted in a common frequency range).

According to further embodiments according to the first aspect of the invention, the data communication apparatus is configured to receive and/or evaluate a configuration information, e.g. one or more system information blocks, indicating one or more dedicated identifiers, e.g. MC-RNTIs and/or BC-RNTIs, associated with shared data, for example, in order to obtain the one or more dedicated identifiers associated with the shared data.

According to further embodiments according to the first aspect of the invention, the data communication apparatus is configured to receive and/or evaluate the configuration information which describes one or more service characteristics, e.g. a type of service, like software update data, audio data, video data, text message data, or the like, and/or a Quality of service information, of the shared data, e.g. in the form of an association between a dedicated identifier (e.g. MC-RNTI) and one or more associated service characteristics (e.g. a service type identifier and/or a quality of service identifier), e.g. in the form of a list of one or more MC-RNTIs and associated additional information, and, for example, to use the service characteristics for a reconstruction of the shared data and/or for deciding whether to request a retransmission of the shared data, or of a part of the shared data, in case of a reception problem.

According to further embodiments according to the first aspect of the invention, the data communication apparatus is configured to receive and/or evaluate an information about an assignment of one or more dedicated identifiers, e.g. MC_RNTIs and/or BC-RNTIs, associated with shared data using a random access procedure or using a dedicated radio resource control, e.g. RRC, signaling, which may, for example, be directed individually to the data communication apparatus.

According to further embodiments according to the first aspect of the invention, the data communication apparatus is configured to receive and/or evaluate an information about an assignment of one or more dedicated identifiers, e.g. MC-RNTIs and/or BC-RNTIs, associated with shared data during a connection establishment, e.g. together with an assignment of a cell radio network temporary identifier, e.g. using a random access procedure, e.g. via or using a 5G Initial access or 5G RACH process.

According to further embodiments according to the first aspect of the invention, the data communication apparatus is configured to extract multicast data from a physical downlink shared channel, e.g. PDSCH, and to extract scheduling information regarding the transmission of the multicast data from a physical downlink control channel, e.g. PDCCH.

According to further embodiments according to the first aspect of the invention, the data communication apparatus is configured to extract broadcast data from a physical downlink shared channel, e.g. PDSCH, and to extract scheduling information regarding the transmission of the broadcast data from a physical downlink control channel, e.g. PDCCH.

According to further embodiments according to the first aspect of the invention, the data communication apparatus is configured to extract unicast data from the physical downlink shared channel, e.g. PDSCH, and to extract scheduling information regarding the transmission of the unicast data from the physical downlink control channel, e.g. PDCCH.

According to further embodiments according to the first aspect of the invention, the data communication apparatus is configured receive and/or evaluate a same scheduling format, e.g. a same type of downlink control information included into the PDCCH, just with different radio network temporary identifiers, to determine the scheduling of shared data, e.g. multicast data or broadcast data, and for determining the scheduling of unicast data.

According to further embodiments according to the first aspect of the invention, the data communication apparatus is configured to establish one or more unicast transmissions with another data communication apparatus to communicate, e.g. transmit or receive, additional information for accessing the shared data, e.g. a key for an encryption of multicast or broadcast data, or side device-specific side information regarding the shared data, and/or for controlling the transmission of the shared data, e.g. for confirming receipt or for requesting a retransmission, or for adapting the provision of the shared data.

According to further embodiments according to the first aspect of the invention, the data communication apparatus is configured to receive the unicast data and the shared data in parallel.

According to further embodiments according to the first aspect of the invention, the unicast data, which may, for example, be associated to the shared data, is adapted for a signaling and/or a control of a processing, e.g. decryption, of the shared data.

According to further embodiments according to the first aspect of the invention, a data rate of unicast data is smaller, e.g. at least by a factor of 2, or at least by a factor of 5 or at least by a factor of 10, than a data rate of the shared data to which the unicast data is associated.

According to further embodiments according to the first aspect of the invention, the data communication apparatus is configured to dynamically change an allocation of transmission resource element positions of the common transmission resource element time-frequency grid, e.g. OFDM symbol and resource block, to, or for example of, shared data and unicast data, e.g. on a slot-by-slot basis, e.g. in accordance with a signaling provided by another data communication apparatus, e.g. in accordance with a variation of a data rate of the shared data, which may, for example, be variable bitrate video and/or audio coding, e.g. using a RNTI-based allocation information, wherein different RNTIs are used for unicast data transmission and shared data transmission.

According to further embodiments according to the first aspect of the invention, the data communication apparatus is configured to extract allocations, e.g. grants conveyed in PDCCH, of transmission resource element positions in the transmission resource element time-frequency grid, e.g. OFDM symbol and resource block, from one or more coresets.

According to further embodiments according to the first aspect of the invention, allocations of transmission resource element positions for a transmission of shared data and allocations of transmission resource element positions of unicast data are extracted from the same corset, or allocations of transmission resource element positions for a transmission of shared data and allocations of transmission resource element positions of unicast data are extracted from different coresets.

According to further embodiments according to the first aspect of the invention, the data communication apparatus is configured to extract allocations, e.g. grants conveyed in PDCCH, of transmission resource element positions in the transmission resource element time-frequency grid for a transmission, or reception or extraction, of shared data from a corset comprising a system information scheduling, e.g. coreset 0.

According to further embodiments according to the first aspect of the invention, the data communication apparatus is configured to receive and/or extract the shared data using multicast transmission resources or using broadcast transmission resources, which are, for example, signaled to be granted for a multicast transmission or for a broadcast transmission. In addition, the data communication apparatus is configured to confirm a receipt of the shared data and/or to request a retransmission of the shared data, or a part of the shared data, e.g. or using a unicast transmission, and the data communication apparatus is configured to extract the retransmitted shared data from multicast transmission resources or from broadcast transmission resources.

According to further embodiments according to the first aspect of the invention, the data communication apparatus is configured to transmit a channel state information or a position information to the other data communication device from which the data communication apparatus receives the shared data, to allow for an adaptation of the beam forming for the transmission of the shared data in dependence on the channel state information or position information.

In the following further embodiments comprising methods according to the first aspect of the invention are discussed.

Further embodiments according to the first aspect of the invention comprise a method for data communication, the method comprising transmitting unicast data to one or more data communication apparatuses, e.g. to one or more UEs and transmitting shared data, e.g. multicast data or broadcast data, to a plurality of data communication apparatuses, e.g. to a plurality of UEs, e.g. within a frame comprising a two-dimensional grid of transmission resource element positions. Furthermore, the unicast data and the shared data are transmitted using a common transmission resource element time-frequency grid, e.g. using a common subcarrier spacing and/or using a common slot length and/or using a common OFDM symbol length.

Further embodiments according to the first aspect of the invention comprise a method for data communication, the method comprising receiving unicast data from at least one data communication apparatuses, e.g. from one or more base stations and/or receiving shared data, e.g. multicast data or broadcast data, from the same or another data communication apparatus, e.g. from a base station, e.g. gNB, e.g. within a frame comprising a two-dimensional grid of transmission resource element positions. Furthermore, the unicast data and shared data are received using a common transmission resource element, e.g. OFDM subcarrier or e.g. OFDM symbol, time-frequency grid, e.g. OFDM symbol and resource block, e.g. using a common subcarrier spacing and/or using a common slot length and/or using a common OFDM symbol length.

The methods are based on the same ideas and/or considerations as explained above in the context of the corresponding data communication apparatuses. Hence, the methods may be supplemented by any of the features, functionalities and details of the corresponding data communication apparatuses.

Further embodiments according to the first aspect of the invention comprise a computer program for performing a method according to embodiments according to the first aspect of the invention, when the computer program runs on a computer.

### SUMMARY OF THE INVENTION ACCORDING TO A SECOND ASPECT OF THE INVENTION

Embodiments according to the second aspect of the invention comprise a data communication apparatus, e.g. a gNB or a base station, for transmitting shared data, e.g. multicast data or broadcast data, to a plurality of other data communication apparatuses, e.g. to a plurality of UEs, e.g. within a frame comprising a two-dimensional grid of transmission resource element positions. Furthermore, the data communication apparatus is configured to transmit the shared data using multicast transmission resources or using broadcast transmission resources, which are, for example, signaled to be granted for a multicast transmission or for a broadcast transmission. Moreover, the data communication apparatus is configured to retransmit the shared data, or a part of the shared data, using multicast transmission resources or using broadcast transmission resources, e.g. “on the multicast channel” or “on the broadcast channel”, in response to a detection of a transmission problem, e.g. in response to a retransmission request from one or more other data communication apparatuses (e.g. a “nack” signaling), or in response to a nonappearance of a confirmation-of-receipt message from one or more other data communication devices.

Embodiments according to the second aspect of the invention are based on the idea to retransmit the shared data, or a part of the shared data, using multicast transmission resources or using broadcast transmission resources, in response to a detection of a transmission problem.

A data communication apparatus according to embodiments is configured to transmit the shared data using multicast transmission resources or broadcast transmission resources. However, the communication channel may distort the transmission of the shared data, or UEs receiving the shared data may fail to evaluate or extract said data. Hence a retransmission may be necessary for UEs to receive the lost information, for example in case a reconstruction based on an error correction is not possible.

Hence, UEs (or in general the other data communication apparatuses) may, for example, transmit a request for a retransmission of shared data or may skip a transmission of a positive acknowledgement of receipt. The detection of the failed transmission may, for example, be performed in the respective UE, e.g. resulting in a request for retransmission, or in the data communication apparatus, e.g. processing feedback data from the UEs.

The inventors recognized that usage of the multicast transmission resources or using broadcast transmission resources, in response to a detection of a transmission problem, for a retransmission of the shared data (or a part) may allow for an efficient error compensation.

As an example, within a cell, a large number of UEs may request a common content, for example a live stream. Errors sources like distorted or bad channels may, for example, affect a plurality of UEs. Therefore, a retransmission for each individual UE failing to receive the common content (in general the shared data) may be inefficient. Hence, the inventors recognized that a retransmission performed via the shared data resources may improve communication significantly.

Moreover, it has also been found that a retransmission of the shared data, or a part of the shared data, using multicast transmission resources or using broadcast transmission resources eliminates the need to allocate individual resources for such a retransmission. Accordingly, a signaling overhead and also a delay imposed by an allocation of individual resources for such a retransmission can be avoided. It has been recognized that the retransmission using the shared resources may therefore in many cases constitute a resource-efficient solution, even if only one UE or a small number of UEs actually require a retransmission.

According to further embodiments according to the second aspect of the invention, the data communication apparatus is configured to retransmit the shared data, or a part of the shared data, in response to a signaling received from one or more other data communication apparatuses, e.g. via or using a unicast channel or via a low rate unicast channel.

The one or more data communication apparatus may detect a failed evaluation or transmission or receiving of the shared data and may therefore provide feedback for the data communication apparatus to retransmit the shared data. This may allow to provide a robust communication.

According to further embodiments according to the second aspect of the invention, the data communication apparatus is configured to retransmit the shared data, or a part of the shared data, in response to a signaling received from one or more other data communication apparatuses via a unicast channel which comprises a data rate which is lower, at least by a factor of 2 or at least by a factor of 5 or at least by a factor of 10 or at least by a factor of 100 or at least by a factor of 1000, than a data rate of the shared data.

As an example, in simple words, the low data rate unicast channel may be used to control the retransmission of the shared data. In yet other words, the unicast channel may be used to control broadcast and/or multicast. Therefore, only a low amount of the data rate available may be used for the unicast channel and a large amount of the data rate available may be used for the transmission and/or retransmission of the shared data, allowing for a high communication efficiency.

As an example, the advantage of such a solution may, for example, be that the unicast channel might require only low capacity, for example since it is used for multicast control only. Bandwidth adaptation can be applied to multicast and may thus facilitate scheduling and may, for example, be keeping the benefit of a one-to-many link. In other words, even if a few UEs need a retransmission, and most of the UEs not, channel capacity can be efficiently used.

According to further embodiments according to the second aspect of the invention, the data communication apparatus is configured to retransmit the shared data, or a part of the shared data, in response to a nonappearance of a confirmation-of-receipt message from one or more other data communication devices, which is expected to arrive, for example, via a unicast channel or via a low rate unicast channel.

This may allow for highly robust communication. The data communication apparatus may, for example, be configured to supervise the transmission of the shared data, for example for safety critical applications, such as autonomous driving. In order to ensure the arrival of the shared data, a retransmission may be performed in case a of a lacking confirmation of receipt message, and not only in case a retransmission is requested.

According to further embodiments according to the second aspect of the invention, the data communication apparatus is configured to allocate transmission resources for a, for example low rate, unicast transmission of a retransmission request (requesting a retransmission of the shared data) or for a transmission of a confirmation-of-receipt (confirming receipt of the shared data) from another data communication apparatus to the data communication apparatus.

As an example, with low amounts of data to be transmitted, retransmission requests and/or confirmations may be transmitted efficiently via unicast resources. Hence, unicast resources may, for example, be used to control a correction of transmission errors, wherein the retransmission itself may be performed via the shared data resources.

According to further embodiments according to the second aspect of the invention, the data communication apparatus is configured to distinguish retransmission requests of another data communication apparatus associated with a transmission of shared data from retransmission requests of the other data communication apparatus associated with a transmission of unicast data.

Alternatively, the data communication apparatus is configured to distinguish confirmation-of-receipt messages of another data communication apparatus associated with a transmission of shared data from confirmation-of-receipt messages of the other data communication apparatus associated with a transmission of unicast data, e.g. using an uplink control information resource, which may, for example, define to which data the confirmation-of-receipt message or the retransmission request is associated.

With distinct information about the kind of request or confirmation, a resource allocation, for a following retransmission may be performed accordingly. Hence resource distribution may be optimized depending on the number of requests or confirmations of the respective unicast or shared data transmission. This may allow for a highly flexibly and efficient communication

In the following further embodiments according to the second aspect of the invention are discussed. The following embodiments may comprise or may be used as counterpart to the beforementioned data communication apparatus.

Hence, as an example, transmitting shared data to a plurality of other data communication apparatuses may correspond to receiving shared data from another data communication apparatuses, the apparatus being configured to transmit the shared data using multicast transmission resources or using broadcast transmission resources may correspond to an apparatus configured to receive and/or extract the shared data using multicast transmission resources or using broadcast transmission resources. Analogously a base station, for example as an example of a data communication apparatus, configured to transmit a signaling or data may correspond to a user equipment or another base station, as an example of a data communication apparatus, configured to receive said signaling or data and vice versa.

Therefore, the features, functionalities and advantages explained above are to be understood in a similar, or corresponding or analogous manner. Accordingly, any of the features, functionalities and details discussed herein above can optionally be used in (e.g. in an identical or analogous manner) in a data communication apparatus as explained in the following and vice versa, both individually and taken in combination.

Further embodiments according to the second aspect of the invention comprise a data communication apparatus, e.g. a gNB or a base station, for receiving shared data, e.g. multicast data or broadcast data, from another data communication apparatuses, e.g. from a base station, gNB, e.g. within a frame comprising a two-dimensional grid of transmission resource element positions. Furthermore, the data communication apparatus is configured to receive and/or extract the shared data using multicast transmission resources or using broadcast transmission resources, which are, for example, signaled to be granted for a multicast transmission or for a broadcast transmission. Moreover, the data communication apparatus is configured to confirm a receipt of the shared data and/or to request a retransmission of the shared data, or of a part of the shared data, e.g. via or using a unicast channel or via a low rate unicast channel, and the data communication apparatus is configured to extract the retransmitted shared data from multicast transmission resources or from broadcast transmission resources.

According to further embodiments according to the second aspect of the invention, the data communication apparatus is configured to confirm the receipt of the shared data, or to request a retransmission of the shared data, or of a part of the shared data, via a unicast channel which comprises a data rate which is lower, at least by a factor of 2 or at least by a factor of 5 or at least by a factor of 10 or at least by a factor of 100 or at least by a factor of 1000, than a data rate of the shared data.

According to further embodiments according to the second aspect of the invention, the data communication apparatus is configured to receive and/or evaluate an allocation of transmission resources for a, for example, low rate, unicast transmission of a retransmission request, for example requesting a retransmission of the shared data, or for a unicast transmission of a confirmation-of-receipt (e.g. confirming receipt of the shared data) from the data communication apparatus to another data communication apparatus.

According to further embodiments according to the second aspect of the invention, the data communication apparatus is configured to distinguish retransmission requests associated with a transmission of shared data from retransmission requests of the other data communication apparatus associated with a transmission of unicast data. Alternatively, the data communication apparatus is configured to distinguish confirmation-of-receipt messages of another data communication apparatus associated with a transmission of shared data from confirmation-of-receipt messages of the other data communication apparatus associated with a transmission of unicast data, e.g. using an uplink control information resource, which may, for example, define to which data the confirmation-of-receipt message or the retransmission request is associated.

In the following further embodiments comprising methods according to the second aspect of the invention are discussed.

Further embodiments according to the second aspect of the invention comprise a method for data communication, the method comprising transmitting shared data, e.g. multicast data or broadcast data, to a plurality of data communication apparatuses, e.g. to a plurality of UEs, e.g. within a frame comprising a two-dimensional grid of transmission resource element symbol positions. The method further comprises transmitting the shared data using multicast transmission resources or using broadcast transmission resources, which are, for example, signaled to be granted for a multicast transmission or for a broadcast transmission. Moreover, the method comprises detecting a transmission problem, e.g. in response to a retransmission request from one or more data communication apparatuses (e.g. a “nack” signaling), or in response to a nonappearance of a confirmation-of-receipt message from one or more data communication devices and retransmitting the shared data, or a part of the shared data, using multicast transmission resources or using broadcast transmission resources, e.g. “on the multicast channel” or “on the broadcast channel”, in response to the detection of the transmission problem.

Further embodiments according to the second aspect of the invention comprise a method for data communication, the method comprising receiving shared data, e.g. multicast data or broadcast data, from a data communication apparatuses, e.g. from a base station, gNB, e.g. within a frame comprising a two-dimensional grid of transmission resource element positions. The method further comprises receiving and/or extracting the shared data using multicast transmission resources or using broadcast transmission resources, which are, for example, signaled to be granted for a multicast transmission or for a broadcast transmission. In addition, the method comprises confirming a receipt of the shared data and/or requesting a retransmission of the shared data, or of a part of the shared data, e.g. via or using a unicast channel or via a low rate unicast channel, and extracting retransmitted shared data from multicast transmission resources or from broadcast transmission resources in case a retransmission is required.

The methods are based on the same ideas and/or considerations as explained above in the context of the corresponding data communication apparatuses. Hence, the methods may optionally be supplemented by any of the features, functionalities and details of the corresponding data communication apparatuses, both individually and taken in combination.

Further embodiments according to the second aspect of the invention comprise a computer program for performing a method according to embodiments according to the second aspect of the invention, when the computer program runs on a computer.

### SUMMARY OF THE INVENTION ACCORDING TO A THIRD ASPECT OF THE INVENTION

Embodiments according to the third aspect of the invention comprise a data communication apparatus, e.g. a gNB or a base station, for transmitting shared data, e.g. multicast data or broadcast data, e.g. simultaneously, to a plurality of other data communication apparatuses, e.g. to a plurality of UEs, e.g. within a frame comprising a two-dimensional grid of transmission resource element positions, and, for example, also for transmitting unicast data to one or more other data communication apparatuses, e.g. to one or more UEs. Furthermore, the data communication apparatus is configured to adapt a beamforming, which may, for example, be achieved using a simultaneous transmission of a plurality of radio frequency signals via a plurality of antennas, wherein the radio frequency signals may, for example, comprise different amplitudes and/or may be phase shifted with respect to each other, in order to perform the beam forming, to a simultaneous transmission of the shared data to the plurality of other data communication apparatuses.

Embodiments according to the third aspect of the invention are based on the idea to adapt a beamforming to a simultaneous transmission of the shared data to the plurality of other data communication apparatuses. The inventors recognized that a beamforming may be applied advantageously for the transmission of shared data. As an example, a plurality of UEs may request a common content, e.g. a video stream. Since, for example, many UEs require the same shared data, namely the video stream, providing the content with shared data resources may be more efficient than providing said content individually as unicast. However, in order to allow for an efficient transmission of the shared data, communication channels to the UEs should have good characteristics, e.g. for a good signal to noise ratio. Hence, the inventors recognized that a shared data transmission may be provided using a beamforming in order to provide good communication channels to the respective UEs, allowing for an efficient communication. The combination of shared data transmission with beamforming may, for example, be implemented with common infrastructure. Base stations, for example as specified in the context of 5G, may be used with minor or even no adaptation in order to adapt beamforming for shared data transmission, for example using the simultaneous transmission of a multitude of radio frequency signals via a plurality of antennas, e.g. via or using an antenna array using an OFDM comprising a plurality of subcarriers.

Using such a concept, it is, for example, possible to deviate from a uniform beamforming, or from a predetermined (“fixed”) multicast or broadcast beamforming pattern. For example, a knowledge of positions of the plurality of UEs to which a multicast or broadcast is made can be used to adapt the beamforming. Consequently, the beamforming can, for example, be made in such a manner that multiple beams are directed to towards individual UEs or groups of UEs. Alternatively or in addition, for example, a knowledge of channel characteristics between the gNB and the plurality of UEs to which a multicast or broadcast is made can be used to adapt the beamforming. Consequently, the beamforming can, for example, be made in such a manner that the beamforming is well-adapted to the channel characteristics between the gNB and the individual UEs or groups of UEs.

To conclude, it has been found that even in a multicast scenario or in a broadcast scenario, a beamforming which is (e.g. simultaneously; e.g. dynamically) adapted to actual positions of different UEs or to channel characteristics between the gNB and multiple UEs is useable and often helpful to improve a resource efficiency. For example, in a simple case, this may be made if most (or all) UEs to be served by a multicast or broadcast are located in very similar directions with respect to the gNB, wherein a single (steered) beam may be directed to all UEs. In a more advanced situation, however, the beamforming may, for example, even be used if multiple UEs, or multiple groups of UEs, are located in significantly different directions with respect to the gNB, wherein multiple (steered) beams may be used to cover the different UEs or groups of UEs.

According to further embodiments according to the third aspect of the invention, the data communication apparatus is configured to adapt the beam forming, to align a plurality of directional beams, or for example transmission lobes, to a plurality of other data communication devices or groups of other data communication devices, e.g. each directional beam to a single other data communication apparatus, or one beam to a single other data communication apparatus and another directional beam to a group of other data transmission apparatuses, or different directional beams to different groups of other data transmission apparatuses.

The data communication apparatus may, for example, comprise a plurality of antennas, e.g. an antenna array. According to a distribution of UEs, and, for example, the required quality of service for each device, the data communication apparatus may adapt its beamforming. The beams or for example lobes, may be adapted in order to fulfill certain requirements. As an example, safety critical UEs may be privileged or favored regarding a quality of the beam they receive. Therefore, such embodiments of the invention may provide a good flexibility and quality and/or efficiency of a communication.

According to further embodiments according to the third aspect of the invention, the data communication apparatus is configured to receive a channel state information and/or a position information from a plurality of other data communication devices to which the data communication device simultaneously transmits the shared data, and wherein the data communication apparatus is configured to adapt the beam forming in dependence on the channel state information and/or position information.

The data communication apparatus may be configured to compensate for a bad or disturbed communication channel, for example by increasing the quality of a beam improving the channel. Furthermore, the data communication apparatus may be configured to track UEs, for example, by continuously updating a beam direction with regard to a position information of a UE or a group of UEs. The data communication apparatus may, for example, be configured to predict a movement trajectory of a UE, for example based on a filtering, such as a Kalman filtering, of position information, for example position information provided by the respective UE. The channel state information and/or the position information may, for example, be transmitted via a unicast channel, for example a parallel low rate unicast channel. This may allow for very good channel characteristics for safety critical applications.

According to further embodiments according to the third aspect of the invention, the data communication device is configured to adapt the beam forming, in order to simultaneously have a plurality of directional beams aligned to a plurality of other data communication devices or groups of other data communication devices to which the shared data are transmitted simultaneously using shared transmission resources, e.g. using shared transmission resource element positions in a two-dimensional grid of transmission resource element positions.

In a communication cell, a plurality of UEs may be present. Hence, the data communication device may, for example, be configured to provide a plurality of directed beams in order to provide communication channels with low disturbance and good signal quality.

According to further embodiments according to the third aspect of the invention, the data communication device is configured to adapt the beam forming, in order to simultaneously have a plurality of directional beams of different beam widths aligned to a plurality of other data communication devices or groups of other data communication devices.

As an example, in some cases it may not be possible to direct an antenna beam to each UE in a cell. Therefore, the data communication device may, for example, address groups of UEs that may be close to each other, with one respective beam. Such a beam may be wider than a beam for a single UE in order to provide enough signal strength for each of the UEs of the group of UEs.

As another example, in case that the number of UEs exceeds the maximum number of beams wider beams can for example be formed, e.g. that cover groups of UEs. In principle the beam widths can for example be adapted from narrow for single users, over medium for clustered groups to omnidirectional.

Hence embodiments allow for a flexible and efficient communication, for example even with limited antenna hardware.

According to further embodiments according to the third aspect of the invention, the data communication apparatus is configured to simultaneously transmit the shared data using multicast transmission resources, e.g. using shared transmission resource element positions in a two-dimensional grid of transmission resource element positions, which are allocated for a multicast transmission, via a plurality of directional beams obtained using the beam forming.

By using multiple directional beams for a simultaneous transmission of the shared data using multicast transmission resources, a transmit power can, for example, be concentrated onto those UEs which are to be served by the multicast or broadcast (or, on other words, onto directions in which UEs which are to be served by the multicast or broadcast are located).

According to further embodiments according to the third aspect of the invention, the data communication apparatus is configured to transmit unicast data and shared data using a common transmission resource element time-frequency grid, e.g. OFDM symbol and resource block, e.g. using a common subcarrier spacing and/or using a common slot length and/or using a common OFDM symbol length.

The data communication apparatus may, for example, be configured to allow for a combined transmission of unicast data and shared data. The inventors recognized that usage of the common transmission resource element time-frequency grid allows for an efficient transmission of the unicast data and the shared data.

In the following further embodiments according to the third aspect of the invention are discussed. The following embodiments may comprise or may be used as counterpart to the before mentioned data communication apparatus.

Therefore, a data communication apparatus, e.g. a base station, for transmitting shared data may correspond to data communication apparatus, e.g. an UE for receiving shared data and vice versa.

Therefore, the features, functionalities and advantages explained above are to be understood in a similar, or corresponding or analogous manner. Accordingly, any of the features, functionalities and details discussed herein above can optionally be used in (e.g. in an identical or analogous manner) in a data communication apparatus as explained in the following and vice versa, both individually and taken in combination.

Further embodiments according to the third aspect of the invention comprise a data communication apparatus, e.g. a UE, wherein the data communication apparatus is configured to receive shared data, e.g. multicast data or broadcast data, from another data communication apparatus, e.g. from a base station, e.g. gNB, e.g. within a frame comprising a two-dimensional grid of transmission resource element positions. Furthermore, the data communication apparatus is configured to transmit a channel state information or a position information to the other data communication device from which the data communication apparatus receives the shared data, to allow for an adaptation of the beam forming for the transmission of the shared data in dependence on the channel state information or position information.

In the following further embodiments comprising methods according to the third aspect of the invention are discussed.

Further embodiments according to the third aspect of the invention comprise a method for data communication, the method comprising transmitting shared data, e.g. multicast data or broadcast data, e.g. simultaneously, to a plurality of data communication apparatuses, e.g. to a plurality of UEs, e.g. within a frame comprising a two-dimensional grid of transmission resource element positions, and, for example, also transmitting unicast data to one or more data communication apparatuses, e.g. to one or more UEs. The method further comprises adapting a beamforming, which may, for example, be achieved using a simultaneous transmission of a plurality of radio frequency signals via a plurality of antennas, wherein the radio frequency signals may, for example, comprise different amplitudes and/or may be phase shifted with respect to each other, in order to perform the beam forming, to a simultaneous transmission of the shared data to the plurality of data communication apparatuses.

Further embodiments according to the third aspect of the invention comprise a method for data communication, the method comprising receiving shared data, e.g. multicast data or broadcast data, from a data communication apparatus, e.g. from a base station, e.g. gNB, e.g. within a frame comprising a two-dimensional grid of transmission resource element positions. The method further comprises transmitting a channel state information or a position information to the data communication device and adapting the beam forming for the transmission of the shared data in dependence on the channel state information or position information.

The methods are based on the same ideas and/or considerations as explained above in the context of the corresponding data communication apparatuses. Hence, the methods may be supplemented by any of the features, functionalities and details of the corresponding data communication apparatuses.

Further embodiments according to the third aspect of the invention comprise a computer program for performing a method according to embodiments according to the third aspect of the invention, when the computer program runs on a computer.

### Summary of the Invention According to a Fourth Aspect of the Invention

Embodiments according to the fourth aspect of the invention comprise a communication system, wherein the communication system comprises an access network, which comprises a plurality of base stations, e.g. a plurality of base stations “gNB”, which are configured to establish a connection with a plurality of user equipments; e.g. a plurality of “data communication apparatuses” as mentioned above. Furthermore, the communication system is configured to use one or more broadcast/multicast user plane functions, e.g. BM-UPF, which are configured to receive shared data, e.g. broadcast data or multicast data, from a data network and to forward the shared data to the access network.

Embodiments according to the fourth aspect of the invention are based on the idea to use one or more broadcast/multicast user plane functions to forward shared data, received from a data network, to an access network. The inventors recognized that usage of specific broadcast/muticast user plane functions allows to incorporate a multi- and/or broadcast functionality in existing communication networks in an efficient way, for example with low additional complexity. Therefore, the broadcast/multicast user plane functions may, for example, be flexible core network entities which may be configured to be set up as standalone components or as intermediate user-plane functions. For example, logical multicast and/or broadcast groups, e.g. described by a Broadcast Multicast Session (MB-Session) may for example, be handled by an instance of the broadcast/multicast user plane function.

As an example, user data may be produced or provided by the data network. The data network may, for example, be a separate entity, e.g. outside the communication network, e.g. located at a random position but coupled to the internet. A UE or a group of UEs may request the user data from the data network. The broadcast/muticast user plane function may, for example, receive the user data from the data network and may forward the user data to the access network and hence, for example via broad- and/or multicast from base stations of the access network, to the UE(s).

Moreover, the user plane functions may, for example, determine to which base stations the shared data should be forwarded, to obtain a sufficient coverage of all UEs. Also, the user plane functions may, for example, contribute to a time synchronization of the transmission of the shared data via multiple base stations.

Accordingly, the user plane functions may, for example, allow for a good resource usage and a good coverage with the shared data.

According to further embodiments according to the fourth aspect of the invention, the one or more broadcast/multicast user plane functions are configured to distribute the shared data to a plurality of the base stations, such that the same shared data are broadcast or multicast via a plurality of base stations.

Therefore, a large number of UEs may be provided with high quality communication channels, e.g. in case a large number of UE requests the same shared data, e.g. a content such as a live stream.

According to further embodiments according to the fourth aspect of the invention, the one or more broadcast/multicast user plane functions are configured to multiply shared data, and to distribute the shared data to a plurality of the base stations.

Hence, every base station may, for example, be provided with the shared data, in order to provide the data to a plurality of UEs in range of the respective base station, therefore allowing to provide the shared data in an efficient manner.

According to further embodiments according to the fourth aspect of the invention, the one or more broadcast/multicast user plane functions are configured to handle a broadcast/multicast session, which describes a logical multicast group or a logical broadcast group.

As an example, the broad- and/or multicasting of user data may for example be defined by Broad-and/or Multicasting Sessions (BM-Session). A BM-Session may, for example, represent the transport of a logical data stream, e.g. by an application, for example starting at the producer located in the data network (DN), e.g. via or using the BM-UPF to the UE. The BM-Sessions can for example be managed and/or controlled by an extension of the existing Session Management Function (SMF), which may, for example, be called Broadcast Multicast SMF (BM-SMF). Therefore, the broadcast/multicast user plane functions may allow to route or direct the information requested by an UE to the UE, for example in an efficient manner.

According to further embodiments according to the fourth aspect of the invention, the communication system comprises a cascade of broadcast/multicast user plane functions, wherein a broadcast/multicast user plane function in a first hierarchic level, e.g. I-BM-UPF, is configured to forward, e.g. distribute, the shared data to two or more broadcast/multicast user plane functions in a second hierarchical level, e.g. BM-UPF, wherein, for example, the broadcast/multicast user plane function in the first hierarchical level may optionally select or filter shared data, for example using one or more downlink classifiers, and/or wherein, for example, there may be several/multiple hierarchy levels (e.g. more than two levels) in which, for example, a filtering may be performed according to different rules, and/or in which a forwarding to different subsequent (e.g. intermediate-) BM-UPFs is performed.

As an example, if multiple base stations need to broad- and/or multicast the user data, the BM-UPF may for example be responsible for multiplying and serving all base stations with data. To enable flexibility, the BM-UPF can also be used as an Intermediate-BM-UPF (I-BM-UPF), which for example forwards the user data, e.g. to several BM-UPFs.

Therefore, a hierarchic structure according to embodiments may allow for an efficient distribution of shared data, in order to provide the shared data to a plurality of UEs, for example being distributed in a large area, such that a plurality of base stations or even access networks may be used for the transmission of the shared data.

According to further embodiments according to the fourth aspect of the invention, the communication system is further configured to use one or more unicast user plane functions, which are configured to receive unicast data, e.g. data intended for a single UE, from a data network and to forward the shared data (and/or the unicast data) to the access network, and/or which are configured to forward unicast data form or, e.g., from the access network, e.g. from a base station of the access network, to the data network.

As an example, vice versa, a UE may, for example, use its unicast connection, e.g. via or using a standard UPF, for example to order, re-order and/or reply e.g. to the broad- and/or multicasted user data. As an example, a unicast user plane function may be used to transmit shared data to the access network in response to unicast data and/or to transmit unicast data to a data network upon receiving the unicast data from the access network.

Hence, embodiments allow for a synergistic usage of unicast user plane functions for the incorporation of inventive concepts for providing shared data, therefore increasing communication efficiency.

According to further embodiments according to the fourth aspect of the invention, the communication system is configured to, for example simultaneously, serve a single data communication apparatus, e.g. a single UE, using one or more broadcast/multicast user plane functions and one or more unicast user plane functions.

As an example, UPFs and BM-UPFs may co-exists, e.g. a UE can be served by multiple UPFs and/or BM-UPFs. As explained before, according to embodiments of the invention, unicast and broadcast/multicast may be used synergistically, for example in parallel, e.g. using corresponding user plane functions, in order to provide a good communication efficiency.

According to further embodiments according to the fourth aspect of the invention, one or more of the broadcast/multicast user plane functions are configured to receive a retransmission request, which is transmitted by a user equipment via a unicast channel, and the broadcast/multicast user plane function is configured to initiate a retransmission of the shared data, or of a part of the shared data, in response to the retransmission request.

As an example, the unicast user plane functions may, for example be used to control and/or schedule usage of the broadcast/multicast user plane functions, hence allowing for an efficient transmission of unicast data, for example re-order or reply or retransmission request and/or shared data, e.g. content requested by a UE.

According to further embodiments according to the fourth aspect of the invention, one or more of the broadcast/multicast user plane functions are configured to receive a retransmission request, which is transmitted by a user equipment via a unicast channel, and the broadcast/multicast user plane function is configured to forward the retransmission request to a data producer or to an application, e.g. an “application function”, which may also be designated with AF according to the 5G terminology, which may, for example, be outside of a core network of the communication system, e.g. outside of the 5G core network, e.g. in the “data network”, e.g. such that the data can be retransmitted there for (or to) a broadcast and/or for (or to) a multicast and/or via a unicast to a recipient.

As an example, if the UE needs to (re-)order data, e.g. if it could not receive and/or is now out of broad- and/or multicast coverage, it can for example place a unicast request to a BM-UPF. This can be done on a direct way and/or via an Intermedia-UPF (I-UPF), which can be configured to handle the UEs unicast traffic and to forward the broad- and/or unicast control requests, e.g. to the related BM-UPFs. Hence, with an architecture according to embodiment a robust communication may be provided.

According to further embodiments according to the fourth aspect of the invention, one or more of the broadcast/multicast user plane functions are configured to receive a retransmission request, which is transmitted by a user equipment via a unicast channel, and the broadcast/multicast user plane function is configured to generate an event, e.g. an event “UE having ID x has missed data, retransmission requested”, in response to the retransmission request and may, optionally, forward this event to one or more other 5G core components, and/or may, optionally, forward this event to one or more external applications (AF) via the existing Network Exposure Function.

In other words, the retransmission request could or may, for example, be forwarded to the data producer or the application “application function” (AF in the 5G terminology) outside of the 5G core network (e.g. within the data network), such that the data can, for example, be transmitted again (e.g. there) for the broadcast/multicast or via unicast to the recipient. In addition, an event can, for example, be generated (e.g. event “UE having ID x has missed data, retransmission requested”) which can, for example, be used by other 5G core components and/or which can, for example, be used by an external application (AF), e.g. via or using the existing Network Exposure Function (NEF).

Therefore, a robust communication may be possible, e.g. a communication being not mainly reliant on a fast latency, but on a complete and errorless data transmission.

According to further embodiments according to the fourth aspect of the invention, the communication system comprises a broadcast/multicast session management function, e.g. BM-SMF, which is configured to control one or more broadcast/multicast sessions, wherein, for example, a broadcast/multicast session represents a transport of shared data (e.g. a logical data stream) from a data source (e.g. a data producer coupled to the data network) to a user equipment (e.g. a UE linked to a base station).

With such a, for example, additional management functionality, robustness and reliability of communication may be improved.

According to further embodiments according to the fourth aspect of the invention, the communication system comprises an access and mobility management function configured to handle a broadcast configuration and/or a multicast configuration of the access network, e.g. of the base stations, e.g. according to a BM session.

The access and mobility management function may, for example, be an extension of a conventional access and mobility function, such that the user data, e.g. provided by the related BM-UPFs can for example be sent to the UEs, e.g. via or using the Access Network, allowing for an efficient communication.

In the following further embodiments comprising methods according to the fourth aspect of the invention are discussed.

Further embodiments according to the fourth aspect of the invention comprise a method for communication, the method comprising using one or more broadcast/multicast user plane functions, e.g. BM-UPF, in order to receive shared data, e.g. broadcast data or multicast data, from a data network and in order to forward the shared data to an access network, wherein the access network comprises a plurality of base stations, e.g. a plurality of base stations “gNB”, which are configured to establish a connection with a plurality of user equipments; e.g. a plurality of “data communication apparatuses” as mentioned above.

The method is based on the same ideas and/or considerations as explained above in the context of the corresponding data communication apparatus. Hence, the method may be supplemented by any of the features, functionalities and details of the corresponding communication system.

Further embodiments according to the fourth aspect of the invention comprise a computer program for performing a method according to embodiments according to the fourth aspect of the invention, when the computer program runs on a computer.

### BRIEF DESCRIPTION OF THE DRAWINGS

Embodiments of the present invention will be detailed subsequently referring to the appended drawings, in which:

FIG. 1 shows a schematic view of a data communication apparatus according to embodiments according to the first aspect of the invention;

FIG. 2 shows a schematic view of a data communication apparatus with additional optional features according to embodiments according to the first aspect of the invention;

FIG. 3 shows a schematic view of a data communication apparatus according to embodiments according to the second aspect of the invention;

FIG. 4 shows a schematic view of a data communication apparatus with additional optional features according to embodiments according to the second aspect of the invention;

FIG. 5 shows a schematic view of a data communication apparatus according to embodiments according to the third aspect of the invention;

FIG. 6 shows a schematic view of a data communication apparatus with additional optional features according to embodiments according to the third aspect of the invention;

FIG. 7 shows a schematic view of a communication system according to embodiments according to the fourth aspect of the invention;

FIG. 8 shows a schematic view of a communication system with additional optional features according to embodiments according to the fourth aspect of the invention;

FIG. 9 shows a schematic block diagram of a first method for data communication according to embodiments according to the first aspect of the invention;

FIG. 10 shows a schematic block diagram of a first method for data communication according to embodiments according to the second aspect of the invention;

FIG. 11 shows a schematic block diagram of a first method for data communication according to embodiments according to the third aspect of the invention

FIG. 12 shows a schematic block diagram of a first method for communication according to embodiments according to the fourth aspect of the invention;

FIG. 13 shows a schematic block diagram of a second method for data communication according to embodiments according to the first aspect of the invention;

FIG. 14 shows a schematic block diagram of a second method for data communication according to embodiments according to the second aspect of the invention;

FIG. 15 shows a schematic block diagram of a second method for communication according to embodiments according to the third aspect of the invention;

FIG. 16 shows an example of User Plane Architecture for Broadcast-Multicast according to an aspect of the invention;

FIG. 17 shows an example for Branching Point BM-UPFs according to an aspect of the invention;

FIG. 18 shows an example of User Plane Architecture for UPF and BM-UPF co-existence according to an aspect of the invention;

FIG. 19 shows an example of Broadcast Multicast SMF within 5G Core Architecture according to an aspect of the invention; and

FIG. 20 shows an example of SSC scenarios showing a movement from area 1 to area 2 according to an aspect of the invention.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

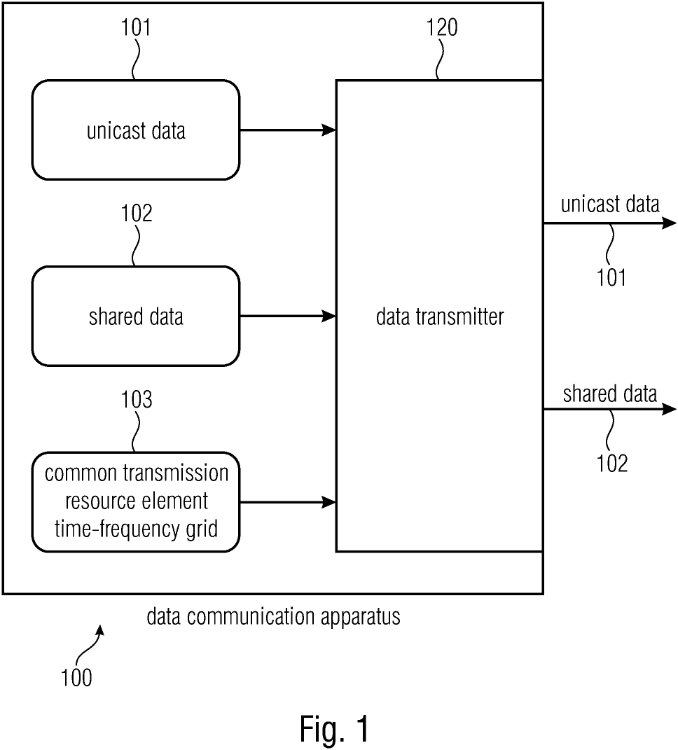

FIG. 1 shows a schematic view of a data communication apparatus according to an embodiment according to the first aspect of the invention. FIG. 1 shows a data communication apparatus 100, optionally comprising a data transmitter 120. Data communication apparatus 100 is configured to transmit, e.g. via or using data transmitter 120, unicast data 101 and shared data 102 using a common transmission resource element time-frequency grid 103. The unicast data 101 and the shared data 102 may be provided for one or more other communication apparatuses.

Shared data 102 may comprise multicast and/or broadcast data. Transmission of the unicast data 101 and/or shared data 102 may, for example, be performed within a frame, e.g. a frame of an OFDM comprising a two-dimensional grid of transmission resource element positions, wherein, as an example, the resource element positions may be determined by the frequency of a subcarrier and a timing information. The common transmission resource element may, for example, be represented by an OFDM subcarrier of an OFDM symbol.

Transmitting the unicast data 101 and the shared data 102 as elements of the same time-frequency grid may allow for an efficient usage of channel capacities.

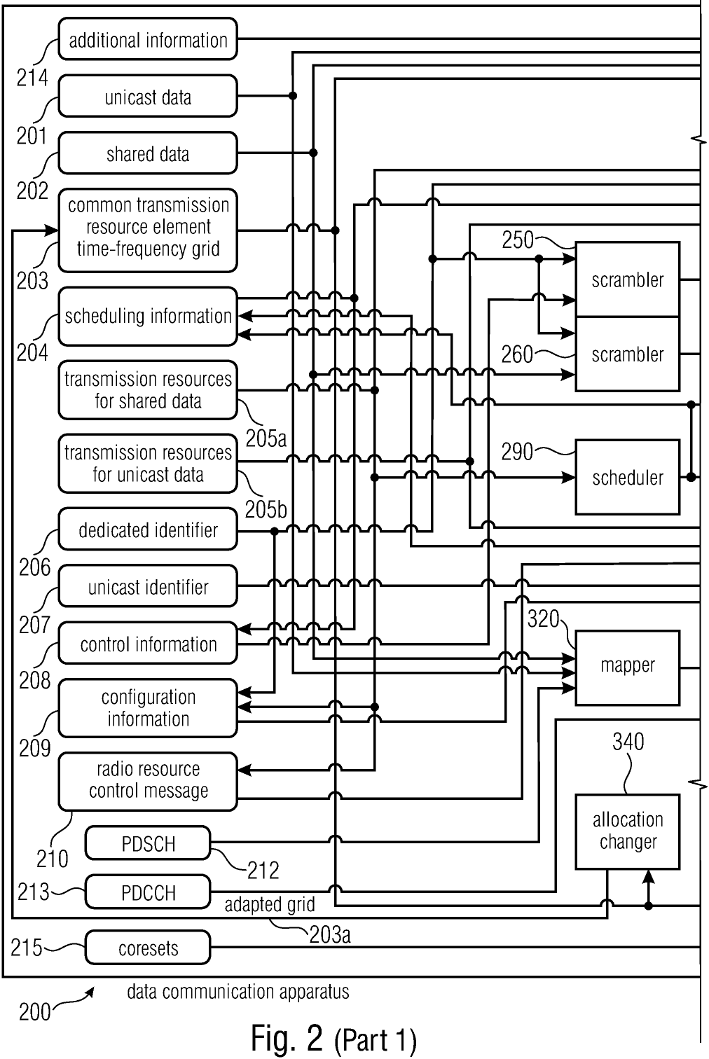

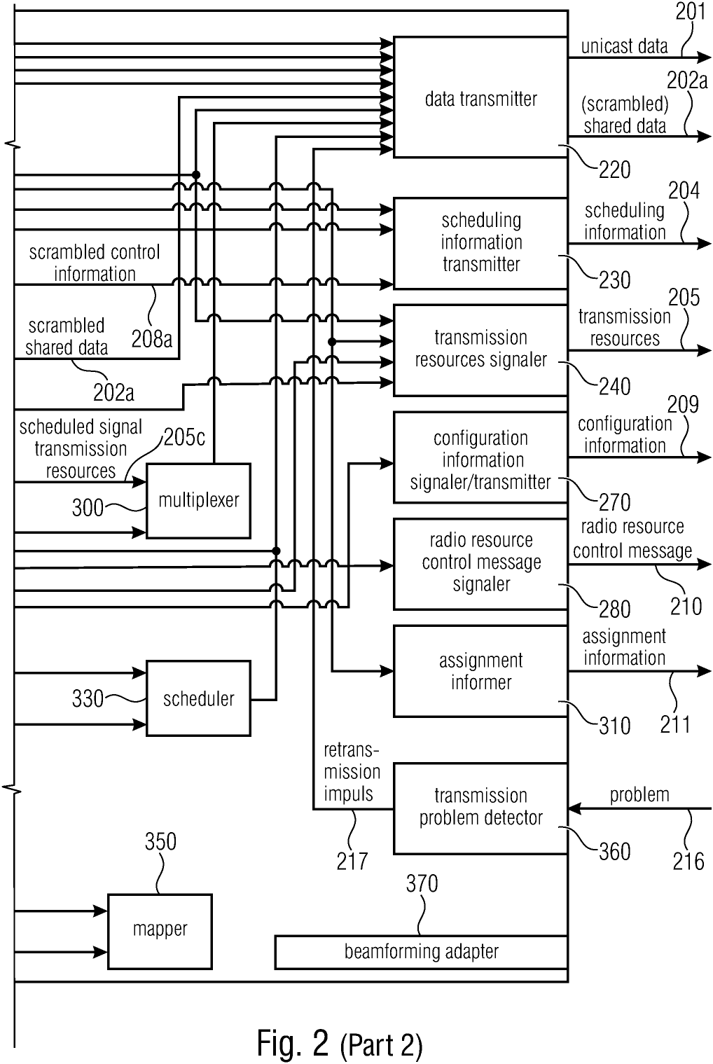

FIG. 2 shows a schematic view of a data communication apparatus with additional optional features according to embodiments according to the first aspect of the invention. FIG. 2 shows data communication apparatus 200, optionally comprising a data transmitter 220. As explained before, Data communication apparatus 200 is configured to transmit, e.g. via or using data transmitter 220, unicast data 201 and shared data 202 using a common transmission resource element time-frequency grid 203. The unicast data 201 and the shared data 202 may be provided for one or more other communication apparatuses.

Optionally, the unicast data 201 and the shared data 202 may be transmitted in parallel. Furthermore, the unicast data 201 may be adapted for a signaling and/or a control of a processing of the shared data 202. Such a processing may, for example, comprise a decryption of the shared data 202. Hence, unicast data 201 may comprise a key, or may, for example be used to provide additional information 214, for example comprising a key, for a decryption of the shared data 202. As another optional feature, the data rate of unicast data 201 may be smaller than a data rate of the shared data 202 to which the unicast data 201 is associated.

As another optional feature, data communication apparatus 200 comprises a scheduling information transmitter 230. The data communication apparatus 200 is configured, e.g. via or using the scheduling information transmitter 230, to transmit a scheduling information 204 via a control channel.

The scheduling information 204 may comprise an information about the structure of the common transmission resource element time-frequency grid 203. As an example, the scheduling information 204 may inform a receiver of the transmission resource element time-frequency grid at which position of the grid the unicast data 201 and/or the shared data 202 are arranged. A resource element may, for example, be represented by a subcarrier of an OFDM symbol.

As another optional feature, data communication apparatus 200 comprises a transmission resources signaler 240. The data communication apparatus 200 is configured, e.g. via or using the transmission resources signaler 240, to transmit a transmission resources signal 205, signaling transmission resources 205a used for the transmission of shared data and/or transmission resources 205a used for the transmission of unicast data.

For the signaling of transmission resources, one or more identifiers are used. For the signaling of signaling transmission resources 205a used for the transmission of shared data 202 one or more dedicated identifiers 206, may be used, For the signaling of signaling transmission resources 205b used for the transmission of unicast data 201 one or more unicast identifiers 207 may be used. The identifiers may be radio network temporary identifiers.

Optionally, the signaling of transmission resources used for the transmission of shared data 202 may be performed in the form of the scheduling information 204. Hence the scheduling information 204 may comprise the transmission resources signal 205. Therefore, the control channel may, for example be a common control channel for signaling both transmission resources for the transmission of unicast data 201 and transmission resources for the transmission of shared data 202.

As another optional feature, data communication apparatus 200 comprises a scrambler 250. The data communication apparatus is configured to generate, e.g. via or using scrambler 250, a scrambling sequence for a scrambling of a control information 208, comprising (as indicated by the arrow from the scheduling information 204 to the control information 208) the scheduling information 204, using a respective dedicated identifier 206. The result may, for example, be a scrambled control information 208a, which may optionally be transmitted, for example via the scheduling information transmitter 230.

As another optional feature, data communication apparatus 200 comprises a second scrambler 260. Optionally, functionality of scrambler 250 and scrambler 260 may be provided by a single scrambler with different inputs and outputs. Data communication apparatus 200 may be configured to generate, e.g. via scrambler 260, a scrambling sequence for a scrambling of shared data 202 using a respective dedicated identifier 206. Hence, scrambled shared data 202a may be provided to the data transmitter 220 and may be transmitted.

Scrambling of the control information and/or the shared data may be performed based on an estimation of the communication channel in order to adapt the bit sequences to be transmitted (the control information 208 or the shared data 202) according to characteristics of the communication channel in order to improve the data transmission.

In addition, the data communication apparatus 200 may be configured to dynamically signal, e.g. via or using transmission resources signal 205, whether transmission resources of a slot are associated with a transmission of shared data 202 or with a transmission of unicast data 201 or both in parallel.

Furthermore, the data communication apparatus 200 may be configured to signal, e.g. via or using transmission resources signal 205, on a per-slot-basis, whether transmission resources of a slot are associated with a transmission of shared data 202 or with a transmission of unicast data 201 or both in parallel.

Consequently, the data communication apparatus 200 may be configured to adapt a transmission of shared data 202 and/or unicast data 201 (e.g. one or the other or both) dynamically, for example with a very fine temporal resolution.

Signaling of the transmission resources 205a, e.g. via or using transmission resources signal 205, for the transmission of the shared data 202 may optionally be performed in a semi-persistent manner, e.g. with a limited validity time of a signal transmission resource allocation which is larger than a slot and/or in a semi-static manner, e.g. with a time granularity which is larger than a slot.

As another optional feature, the data communication apparatus 200 comprises a configuration information signaler/transmitter 270. Data communication apparatus 200 may be configured to signal transmission resources 205a, e.g. via or using configuration information signaler/transmitter 270, for the transmission of the shared data in a configuration information 208. Therefore optionally, configuration information 208 may comprise an information about the transmission resources 205a for shared data as indicated by the arrow from the transmission resources 205a for shared data to the configuration information 208. Hence, transmission resources signaler 240 and configuration information signaler/transmitter 270 may be alternatives or, for example, a single element. The configuration information may, for example, be or may comprise or may, for example, be incorporated in one or more system information blocks. The configuration information 208 may, for example, be transmitted regularly, for example, once withing a specific number of slots, or irregularly.

Optionally, configuration information 208 may comprise an information indicating one or more dedicated identifiers 206 associated with shared data 202, e.g. as indicated by the arrow from dedicated identifier 206 to the configuration information 208. Hence, such information about the dedicated identifiers 206 may be transmitted via the configuration information signaler/transmitter 270.

Optionally, the data communication apparatus 200 may be configured to transmit the configuration information 206, such that the configuration information 206 describes one or more service characteristics of the shared data 202. Hence, the configuration information 206 may comprise an information about service characteristics, e.g. a quality of service information and/or the type of content or service provided with the shared data, for example, an information like “audio data”, “video data”, or “software update data”. This information may be provided as an association between the dedicated identifier 206, e.g. an MC-RNTI and the service characteristics.

As another optional feature, the data communication apparatus 200 comprises a radio resource control message signaler 280. Data communication apparatus 200 may be configured to signal transmission resources 205a, e.g. via or using radio resource control message signaler 280, for the transmission of the shared data 202 in radio resource control message 210, which is directed to a single other data communication apparatus. Therefore optionally, radio resource control message 210 may comprise an information about the transmission resources 205a for shared data as indicated by the arrow from the transmission resources 205a for shared data to the radio resource control message 210. Hence, radio resource control message signaler 280 and configuration information signaler/transmitter 270 may be alternatives or, for example, a single element.

As another optional feature, the data communication apparatus 200 comprises a scheduler 290 and a multiplexer 300. Data communication apparatus 200 may be configured to schedule, e.g. via or using a scheduler 290, signal transmission resources 205a for the transmission of the shared data 202, to be, e.g. via or using multiplexer 300, time-multiplexed and/or frequency multiplexed with signal transmission resources 205b for the transmission of unicast data 201. An output of the scheduler 290, e.g. a scheduled signal transmission resources 205c of the shared data may be used (e.g. as indicated by the arrow from the scheduler 290 to the scheduling information 204) to update the scheduling information 204. In addition, the scheduled signal transmission resources 205c of the shared data may be transmitted via the transmission resources signaler 240, for example as updated, e.g. scheduled, transmission resources 205. Optionally the scheduled signal transmission resources 205c may be used to update the transmission resources 205a for shared data and/or the control information, the configuration information, and/or the radio resource control message (not shown) and/or an association information of the dedicated identifiers 206. In simple words, any of the parameters providing an information about the transmission of unicast data 201 and/or shared data 202 may be updated according to adaptations performed by other elements of data communication apparatus 200, e.g. as explained in the context of scheduler 290. However, it should be noted that the multiplexer does not necessarily need to be part of the data communication apparatus 200, but could also be external to the data communication apparatus.

Multiplexer 300 is only an optional feature. Multiplexing of the shared data 202 may, for example, be performed outside the data communication apparatus 200, such that the data communication apparatus 200 may only schedule the multiplexing and inform the respective device to perform a multiplexing accordingly.

Multiplexing may be performed in any suitable manner, for example in time, e.g. time-multiplexing, in frequency, e.g. frequency-multiplexing or in both. Hence, in a same bandwidth part, e.g. for a same number of frequencies, e.g. subcarrier frequencies, unicast data 201 and shared data 202 may be time-multiplexed, e.g. ordered with respect to their transmission time. Alternatively, or in addition, unicast data 201 and shared data 202 may be transmitted at the same time, or time slot but with separate or different bandwidths, e.g. on different subcarriers comprising different subcarrier frequencies. Furthermore, a combination of time-multiplexing and frequency-multiplexing may be performed, e.g. such that unicast data 201 (e.g. associated with PDSCH) and shared data 202 (e.g. associated with PDSCH) may be transmitted alternatingly in time and for different frequencies.

An output of multiplexer 300 may therefore optionally be coupled (not shown) with the common transmission resource element time frequency grid 203, in order to update grid 203 based on the multiplexing.

Optionally, as shown, the output of the multiplexer 300, may be provided to the data transmitter 220. Hence, multiplexing of the signal transmission resources 205a, 205b for the transmission of unicast data/shared data may be used to adapt the transmission of the unicast data 201 and the shared data 202.

As another optional feature, the data communication apparatus 200 comprises an assignment informer 310. Data communication apparatus 200 may be configured to inform one or more other data communication apparatuses, e.g. via or using assignment informer 310, about an assignment of one or more dedicated identifiers 206 associated with shared data using a random access procedure or using a dedicated radio resource control signaling. Optionally, informing the one or more other data communication apparatuses about an assignment of one or more dedicated identifiers 206 associated with shared data may be performed during a connection establishment. The respective assignment information 211 may be transmitted to the one or more communication apparatuses.

As an optional example, data communication apparatus 200 may comprise one or more means for the transmission of data, namely unicast data 201 and/or shared data 202, and for the transmission of meta information, that may be used by a receiver, for example by one or more other data communication apparatuses, in order to read or evaluate the transmitted data. Unicast data 201 and shared data 202 may, for example, be transmitted efficiently using the common transmission resource element time-frequency grid 203. Unicast data 201 and shared data 202 may be time-multiplexed and/or frequency multiplexed. A scheduling of the transmission of unicast data 201 and shared data 202, may be performed by a scheduler 290, as explained before, for example before multiplexing (e.g. before a multiplexing of the unicast data 201 and the shared data 202 to resource elements of the common transmission resource element time-frequency grid 203) . Hence, a receiver may, for example, be informed which resource element positions of the common transmission resource element time-frequency grid 203 comprise or are used for or are associated with unicast data 201 and which resource element positions of the common transmission resource element time-frequency grid 203 comprise or are used for or are associated with shared data 202. Therefore, data communication apparatus may transmit one or more parameters suitable for interpreting the signalings provided. Hence, any combination of, for example, scheduling information 204, transmission resources 205 information, configuration information 209 and/or assignment information 211 may be provided, in order to describe which transmission resource element positions of the common transmission resource element time-frequency grid 203 are used for the transmission of shared data 202 and/or for the transmission of unicast data 201. The shared data 202 may, for example, be transmitted in the PDSCH, wherein the information used for an interpretation of the resource element positions may, for example, be transmitted in the PDCCH.

As another optional feature, the data communication apparatus 200 comprises a mapper 320 and a second scheduler 330. Data communication apparatus 200 may be configured to map unicast data 201 and/or shared data 202, e.g. multicast data and/or broadcast data, e.g. via or using mapper 320, onto a physical downlink shared channel (PDSCH) 212 and, e.g. via or using scheduler 320, to schedule the transmission of the unicast data 201 and/or shared data 202 using a physical downlink control channel (PDCCH) 213. The result of the procedure may, optionally be used to update the scheduling information 204 or to adapt the transmission of the unicast data 201 and/or shared data 202 for transmission, e.g. via or using data transmitter 220.

Optionally, the data communication apparatus 200 may be configured to use a same scheduling format, e.g. a same type of downlink control information included into the PDCCH 213, just with different radio network temporary identifiers, for the scheduling of shared data 202 and for the scheduling of unicast data 201.

Optionally, the data communication apparatus 200 may be configured to establish one or more unicast transmissions, e.g. via or using data transmitter 220, with another data communication apparatus to communicate additional information 214 for accessing the shared data 202 and/or for controlling the transmission of the shared data 202. Apart from the information needed to interpret a position of a resource element in the common transmission resource element time-frequency grid 203, additional information 214 such as encryption information, e.g. a key for decryption of the shared data 202 or individual, e.g. UE specific information for the shared data 202 may be provided.

As another optional feature, the data communication apparatus 200 comprises an allocation changer 340. Data communication apparatus 200 may be configured to dynamically change an allocation of transmission resource element positions of the common transmission resource element time-frequency grid 203 to shared data 202 and unicast data 201, e.g. via or using allocation changer 340,. Hence, optionally an output of the allocation changer may be an adapted transmission resource element time-frequency grid 203a, that may be used to update the common transmission resource element time-frequency grid 203.

Dynamically changing the allocation may allow for a real time adaptation of type of content and quality of content demands (ore quality of service demands). As an example, in case a large number of UEs requests a same video content, quickly changing allocations of unicast data 201 and shared data 202 to the resource elements may allow to provide the requested content without service delays and in good quality. Thus, by using a flexible allocation, a bitrate available for multicast or broadcast transmission can be adapted to the need rapidly, thereby resulting in a high resource efficiency.

As another optional feature, the data communication apparatus 200 may, for example, comprise a second mapper 350. Data communication apparatus 200 may be configured to map, e.g. via second mapper 350, allocations of transmission resource element positions in the transmission resource element time-frequency grid 203 to coresets 215, such that allocations of transmission resource element positions for a transmission of shared data and allocations of transmission resource element positions of unicast data are mapped into the same corset 215, or such that allocations of transmission resource element positions for a transmission of shared data and allocations of transmission resource element positions of unicast data are mapped into different coresets 215.

Optionally, the data communication apparatus may be configured to map, e.g. via or using second mapper 350, allocations of transmission resource element positions in the transmission resource element time-frequency grid 203 for a transmission of shared data may to a corset comprising a system information scheduling.

As another optional feature, the data communication apparatus 200 comprises a transmission problem detector 360. Data communication apparatus 200 may be configured to detect a transmission problem 216 or to receive an information about a transmission problem, e.g. via or using transmission problem detector 360. The data communication apparatus may be configured to transmit the shared data 202 using multicast transmission resources or using broadcast transmission resources and to retransmit the shared data 202, or a part of the shared data, using multicast transmission resources or using broadcast transmission resources in response to a detection of a transmission problem 216. Hence, transmission problem detector 360 may send a retransmission impulse 217 or for example retransmission request, to the data transmitter 220 for a retransmission of the shared data 220.

As another optional feature, the data communication apparatus 200 may comprise a beamforming adapter 370. Data communication apparatus 200 may be configured to adapt, e.g. via beamforming adapter 370, a beamforming to a simultaneous transmission of the shared data 202 to the plurality of other data communication apparatuses.

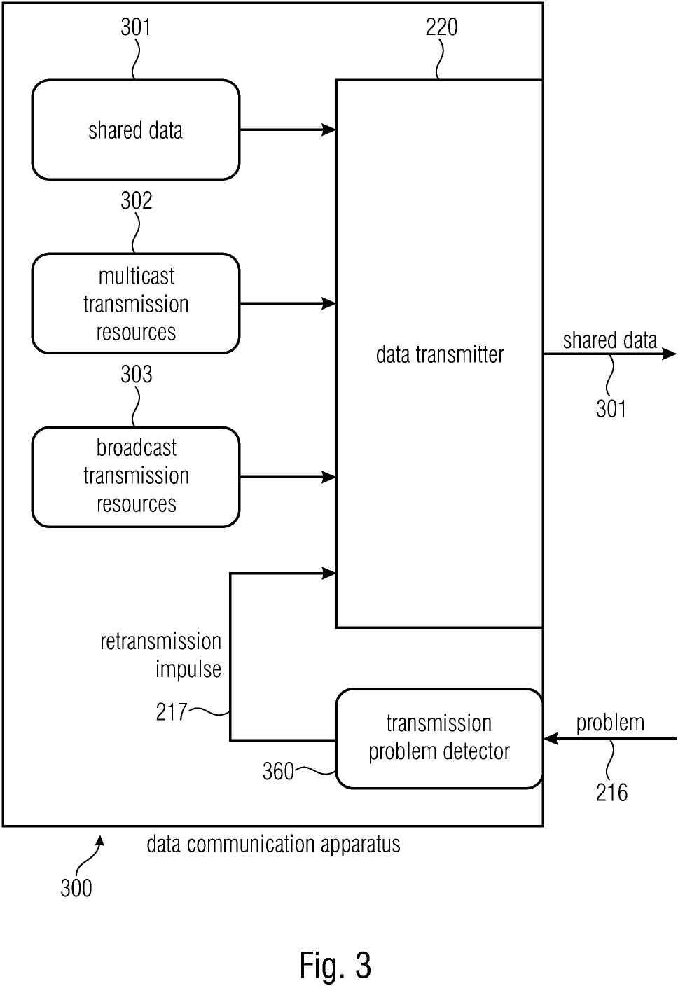

FIG. 3 shows a schematic view of a data communication apparatus according to embodiments according to the second aspect of the invention. FIG. 3 shows data communication apparatus 300, for example, a gNB or a base station, for transmitting shared data 301. The shared data 301 may comprise multicast data and/or broadcast data and may be transmitted to a plurality of other data communication apparatuses. The data communication apparatus 300 is configured to transmit, e.g. via or using optional data transmitter 220, the shared data 301 using multicast transmission resources 302 or using broadcast transmission resources 303. Furthermore, the data communication apparatus 300 comprises, as an optional feature, a transmission problem detector 360. The data communication apparatus 300 is configured to detect a transmission problem 216, e.g. via or using the transmission problem detector 360. The data communication apparatus 300 is configured to retransmit the shared data 301, or a part of the shared data using the multicast transmission resources 302 or using the broadcast transmission resources 303, in response to the detection of the transmission problem 216. Hence, optionally, transmission problem detector 360 may provide a retransmission impulse 217 to the data transmitter 220, in case a transmission problem 216 is present, in order to trigger the retransmission. Optionally, transmission resources may be adapted in order to allow for a retransmission of the shared data 301.

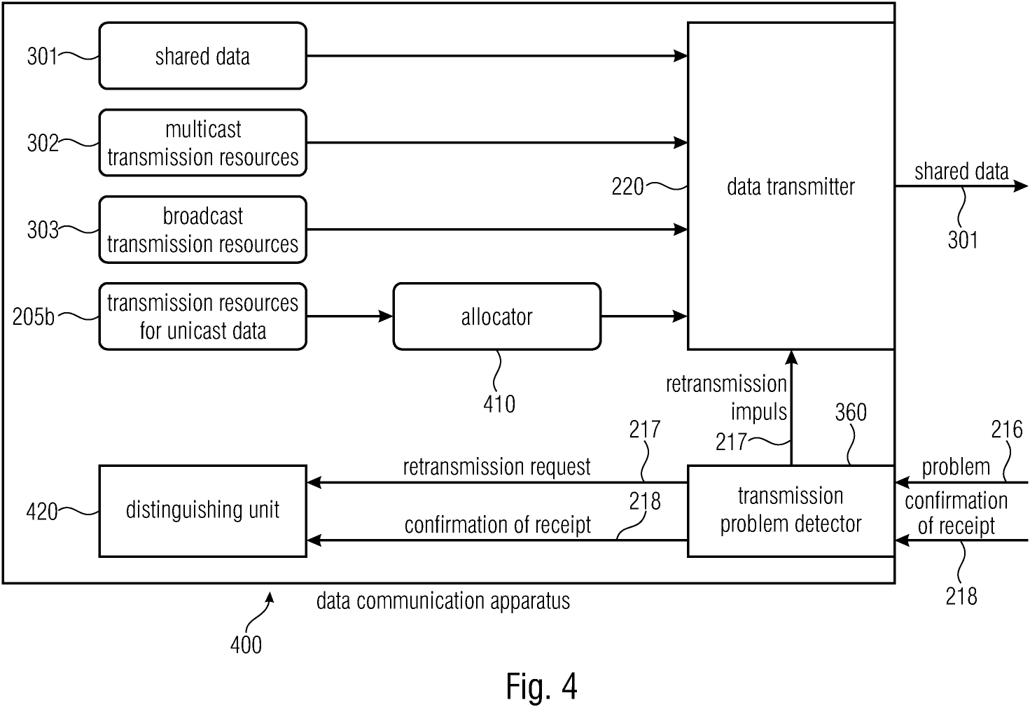

FIG. 4 shows a schematic view of a data communication apparatus with additional optional features according to embodiments according to the second aspect of the invention. In addition to the elements explained in FIG. 3, data communication apparatus 400 comprises, optionally, an allocator 410 and a distinguishing unit 420.

As an optional feature, data communication apparatus 400 may be configured to retransmit the shared data, or a part of the shared data, in response to a signaling received from one or more other data communication apparatuses. The data communication apparatus 400 may be configured to receive feedback from other data communication apparatuses, e.g. via or using transmission problem detector 360. Hence, a signaling of such another data communication apparatus may be a confirmation of receipt signaling 218 or an information about a transmission problem 216. In response to an evaluation of such a signaling, e.g. a request for retransmission, or a signaling comprising an information about a transmission problem, or a nonappearance of a confirmation of receipt 218, the data communication apparatus may retransmit the shared data 301.

To put it in other words, the data communication apparatus may be configured to retransmit the shared data 301, or a part of the shared data, in response to a nonappearance of a confirmation-of-receipt message 218 from one or more other data communication devices.

Problem or confirmation signalings may be received via a unicast channel, for example, a low rate unicast channel. As explained before, the inventors recognized that a unicast transmission may be used in order to control the (re-)transmission and resource allocation (e.g. in case of a retransmission) of shared data in order to improve communication efficiency.

As another optional feature, the data communication apparatus 400 may be configured to retransmit the shared data 301, or a part of the shared data, in response to a signaling, e.g. a problem 216, received from one or more other data communication apparatuses via a unicast channel which comprises a data rate which is lower, at least by a factor of 2 or at least by a factor of 5 or at least by a factor of 10 or at least by a factor of 100 or at least by a factor of 1000, than a data rate of the shared data. As explained before, a low data rate unicast channel may be used in order to schedule or control or regulate the transmission or retransmission of shared data 301.

As another optional feature, the data communication apparatus 400 may be configured to allocate, e.g. via or using allocator 410, transmission resources 205b for a unicast transmission of a retransmission request (requesting a retransmission of the shared data) or for a transmission of a confirmation-of-receipt (confirming receipt of the shared data 301) from another data communication apparatus to the data communication apparatus 400.

As another optional feature, the data communication apparatus 400 may be configured to distinguish, e.g. via or using distinguishing unit 420, retransmission requests 217 of another data communication apparatus associated with a transmission of shared data from retransmission requests of the other data communication apparatus associated with a transmission of unicast data. Alternatively, the data communication apparatus may be configured to distinguish confirmation-of-receipt messages 218 of another data communication apparatus associated with a transmission of shared data from confirmation-of-receipt messages of the other data communication apparatus associated with a transmission of unicast data. The retransmission requests 217 and/or the confirmation of receipt messages 218 may, for example as shown, provided by the transmission problem detector 360, for example to perform an evaluation whether a transmission problem occurred. However, signalings received by the data communication apparatus 400 may as well be routed directly to the distinguishing unit 420. This may allow for a distinct information about a successful transmission of shared data or unicast data. Based thereon, a scheduling of future transmission resources may be performed in order to balance a transmission of unicast data and shared data as well as a transmission of new data or a retransmission of old data. Hence, communication may be performed efficiently.

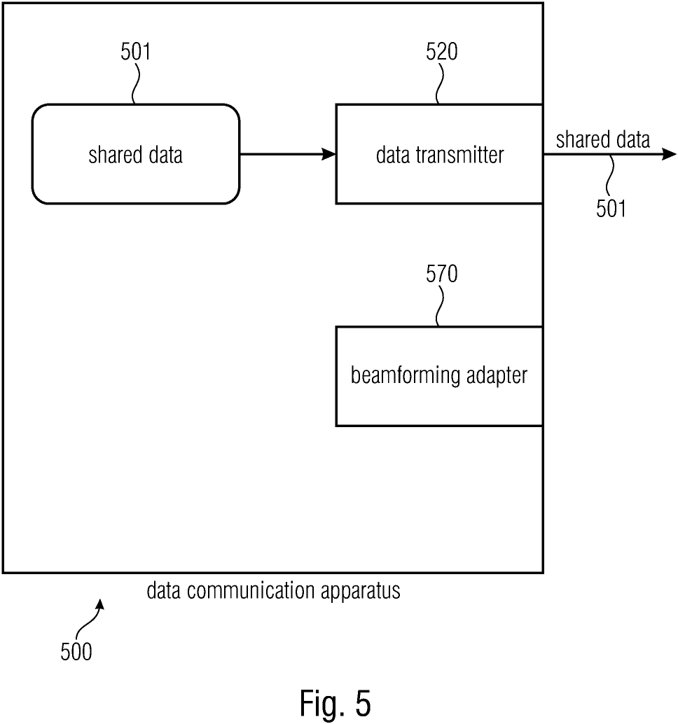

FIG. 5 shows a schematic view of a data communication apparatus according to embodiments according to the third aspect of the invention. FIG. 5 shows data communication apparatus 500, e.g. a gNB or a base station, for transmitting, e.g. via or using optional data transmitter 520 as shown, shared data 501, e.g. multicast data or broadcast data, e.g. simultaneously, to a plurality of other data communication apparatuses, e.g. to a plurality of UEs, e.g. within a frame comprising a two-dimensional grid of transmission resource element positions, and, for example, also for transmitting unicast data to one or more other data communication apparatuses, e.g. to one or more UEs. The data communication apparatus 500 is configured to adapt, e.g. via or using an optional beamforming adapter 570 as shown, a beamforming, which may, for example, be achieved using a simultaneous transmission of a plurality of radio frequency signals via a plurality of antennas, wherein the radio frequency signals may, for example, comprise different amplitudes and/or may be phase shifted with respect to each other, order to perform the beam forming, to a simultaneous transmission of the shared data 501 to the plurality of other data communication apparatuses.

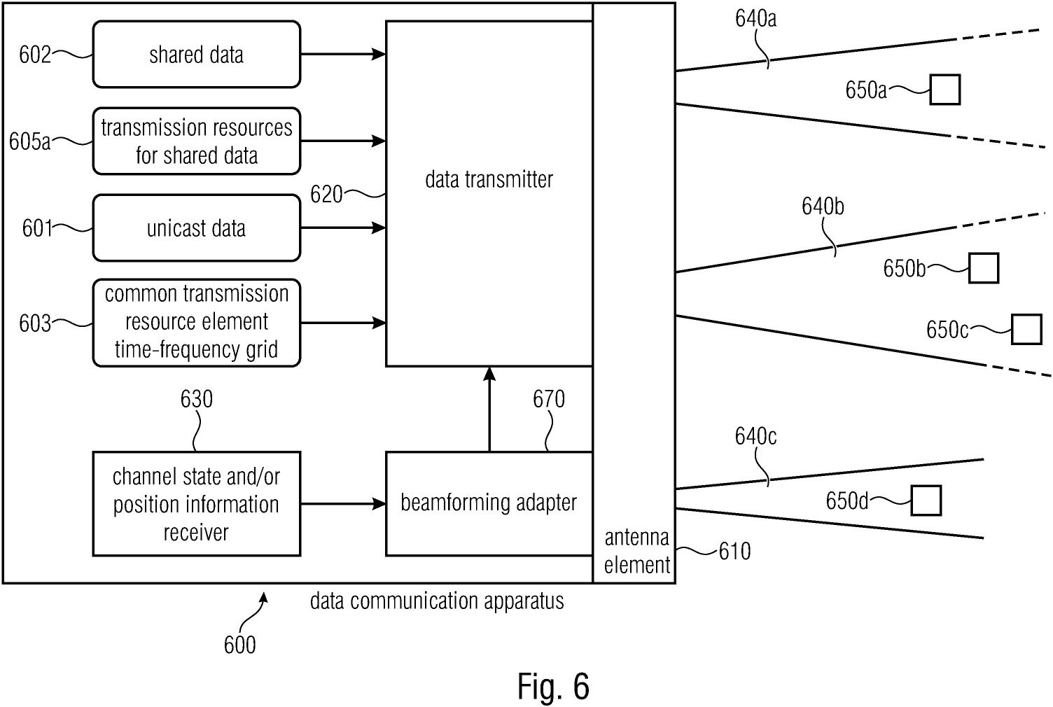

FIG. 6 shows a schematic view of a data communication apparatus with additional optional features according to embodiments according to the third aspect of the invention. Apart from the elements explained in FIG. 5 (shared data 601, data transmitter 620 and beamforming adapter 670), data communication apparatus 600 comprises, optionally, a channel state and/or position information receiver 630 and an optional antenna element 610. The antenna element 610 may optionally comprise a plurality of antennas, and may, for example, be configured to transmit and/or receive radio frequency signals, for example, comprising different amplitudes and/or different phase shifts with respect to each other. Antenna element 610 may be configured perform the beam forming based on an input provided by the beamforming adapter 670. As an example, beams 640 a-c aligned with other data communication apparatuses 650 a-d are shown. The transmitted shared data 501 as shown in FIG. 5 outside the apparatus 500 is not shown for the sake of clarity. Sigalings provided by the communication apparatus 600 and/or communication apparatus 200, may be provided via the beams 640 a-c.

As an optional feature, data communication apparatus 600 may be configured to adapt the beam forming, e.g. via or using beamforming adapter 670, to align a plurality of directional beams 640 a-c, or transmission lobes, to a plurality of other data communication devices 650a, 650d or groups of other data communication devices 650b, 650c, e.g. each directional beam to a single other data communication apparatus or one beam to a single other data communication apparatus, as shown with beams 640a to apparatus 650a and beam 650c to apparatus 650d, and another directional beam to a group of other data transmission apparatuses, as shown with beam 640b to a group comprising apparatus 650b and apparatus 650c, or different directional beams to different groups of other data transmission apparatuses. In simple words, the beams 640a-c may, for example be directed on or oriented towards UEs within reach of the antenna element 610, therefore improving communication channel characteristics.

As another optional feature, the data communication apparatus 600 may be configured to receive, e.g. via or using optional channel state and/or position information receiver 640, a channel state information and/or a position information from a plurality of other data communication devices 650 a-d, e.g. via or using antenna element 610, to which the data communication device simultaneously transmits the shared data, and wherein the data communication apparatus is configured to adapt the beam forming, e.g. via or using beamforming adapter 670 in dependence on the channel state information and/or position information. The channel state may be estimated based on a signaling received by the channel state information. Hence, UEs with low computational abilities may only provide information necessary to estimate the channel state to the data communication apparatus 600. Therefore, data communication apparatus may comprise a channel state estimation unit (not shown). However, optionally, data communication apparatus 600 may receive an estimation of the channel. The position information may, for example, be a GPS information, or a directional information.

As another optional feature, the data communication device 600 may be configured to adapt the beam forming, e.g. via or using beamforming adapter 670, in order to simultaneously have a plurality of directional beams 640 a-c aligned to a plurality of other data communication devices 650a, 650d or groups of other data communication devices 650b, 650c to which the shared data are transmitted simultaneously using shared transmission resources 605a. Therefore, even in case not every single data communication device 650 a-d can be provided with an individual beam, groups of apparatuses, e.g. UEs may receive single beams, adapted to provide a good communication channel.

As another optional feature, the data communication device 600 may be configured to adapt the beam forming, e.g. via or using beamforming adapter 670, in order to simultaneously have a plurality of directional beams of different beam widths, aligned to a plurality of other data communication devices or groups of other data communication devices e.g. as shown beam 640b being wider in order to provide a good signal quality for both data communication apparatuses 650b-c, in contrast to beams 640a and 640c that may be thinner, since they only address one data communication apparatus each. However, for example according to communication channel characteristics, beams 640a and 640c may have different widths as well. This may allow for a data transmission with a low amount of disturbances.

As another optional feature, data communication apparatus 600 may be configured to simultaneously transmit the shared data 602 using multicast transmission resources via a plurality of directional beams 640 a-d obtained using the beam forming, e.g. using beamforming adapter 670. The transmission resources for shared data 605a may comprise transmission resources for multicast transmission and transmission resources for broadcast transmission.

As another optional feature, the data communication apparatus 600 may be configured to transmit unicast data 601 and shared data 602 using a common transmission resource element time-frequency grid 603, e.g. as explained before.

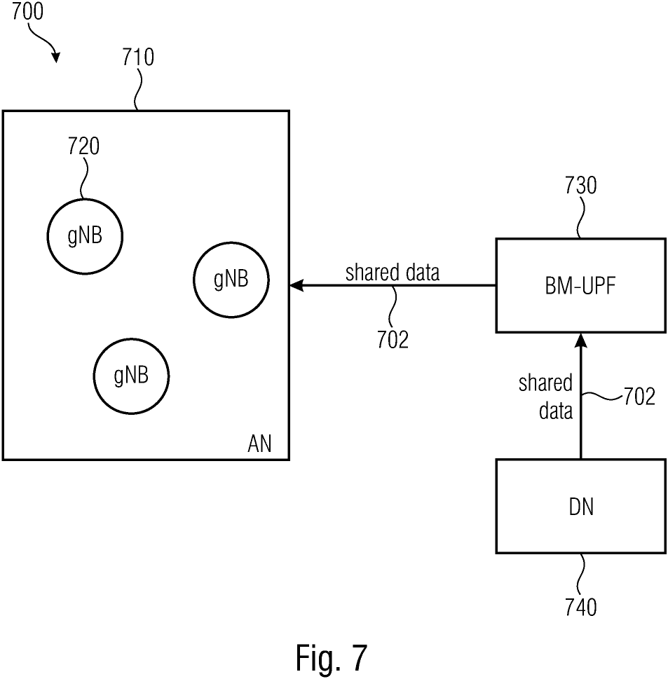

FIG. 7 shows a schematic view of a communication system according to embodiments according to the fourth aspect of the invention. FIG. 7 shows a communication system 700 comprising an access network (AN) 710, comprising a plurality of base stations (gNB) 720. Via a broadcast/multicast user plane function (BM-UPF) 730, shared data 702 from a data network 740 may be forwarded to the AN 710. The plurality of base stations 720 is configured to establish a connection with a plurality of user equipments (UEs) (not shown). In addition, shared data 702 may comprise broadcast data and/or multicast data.

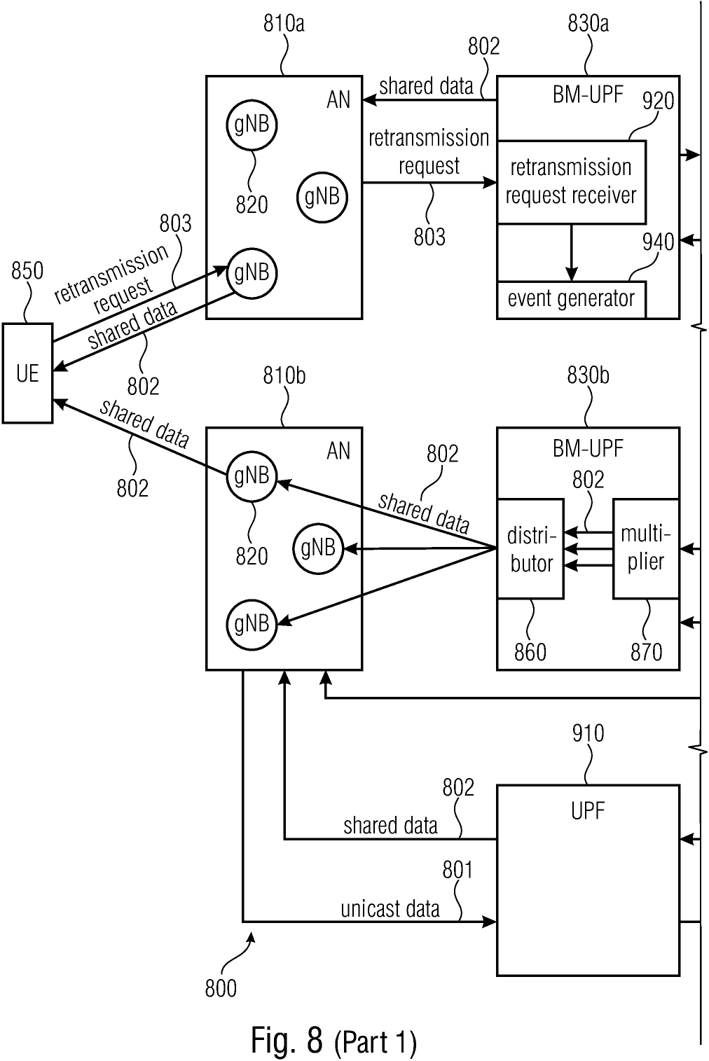

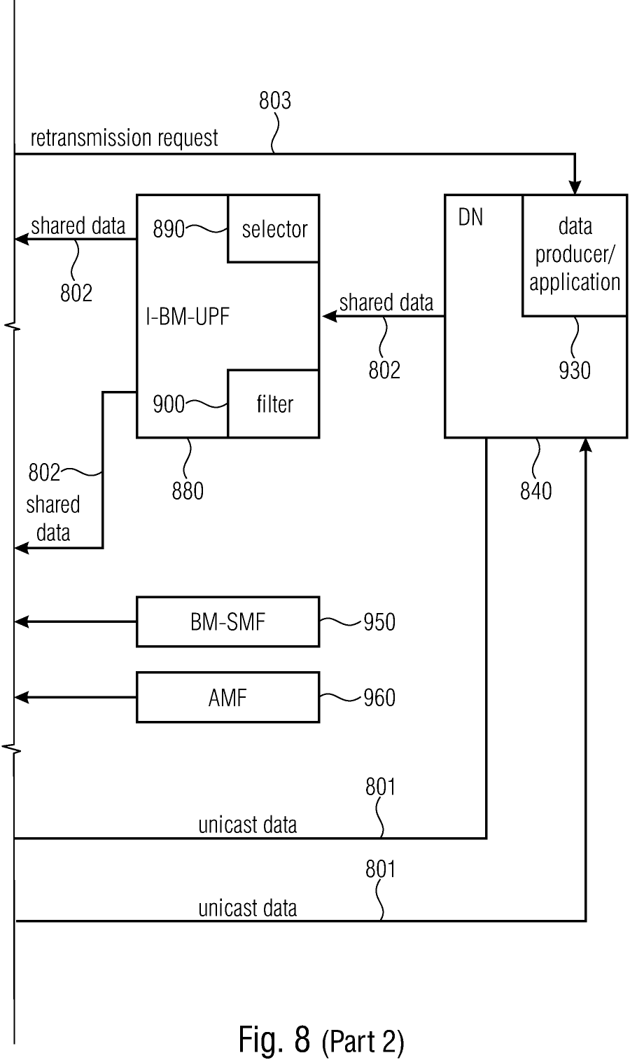

FIG. 8 shows a schematic view of a communication system with additional optional features according to embodiments according to the fourth aspect of the invention. The communication system shown FIG. 8 comprises, as an optional feature a first access network 810a and a second access network 810b both comprising a plurality of base stations 820 and a first broadcast/multicast user plane function 830a and a second broadcast/multicast user plane functions 830b. Both broadcast/multicast user plane functions 830a, 830b are configured to receive shared data 802 and to forward the shared data to the access networks 810a, 810b.

The shared data 802 may then be transmitted or forwarded to a user equipment 850, for example another data communication apparatus.

As an optional feature, the second broadcast/multicast user plane functions 830b comprises a distributor 860, configured to distribute the shared data 802 to a plurality of the base stations. The distributor may be configured to distribute the shared data 802 to all base stations 820 of an access network 810b, as shown, or to a subset or partial quantity of the base stations 820 of an access network 810b.

As another optional feature, the second broadcast/multicast user plane functions 830b comprises a multiplier 870, configured to multiply shared data. The multiplied, shared data may then be distributed by distributer 860, as explained before. Hence, the shared data 802 may be provided to a large number of base stations 820, for example, to provide a content requested to a large number of user equipments 850, e.g. devices such as smartphones, tablets or laptops.

As another optional feature, the one or more broadcast/multicast user plane functions may be configured to handle a broadcast/multicast session, which describes a logical multicast group or a logical broadcast group.

As another optional feature, FIG. 8 shows the communication system comprising a cascade broadcast/multicast user plane functions. The broadcast/multicast user plane functions may be arranged in hierarchic levels, for example with broadcast/multicast user plane functions in a first hierarchic level providing signals to broadcast/multicast user plane functions in a second hierarchic level. As an example, the communication system shown in FIG. 8 shows two hierarchic levels (however more hierarchic levels are possible). The first hierarchic level comprises the broadcast/multicast user plane function I-BM-UPF 880, the second hierarchic level the beforementioned first and second broadcast/multicast user plane functions 830a, 830b. It is to be noted that the hierarchic levels may comprise a plurality of broadcast/multicast user plane functions, for example in any arbitrary relationship, e.g. not necessarily in a relation of 2:1 (meaning, as an example, that one broadcast/multicast user plane function of a lower layer addresses 2 broadcast/multicast user plane functions in a higher layer) as shown in FIG. 8.

Broadcast/multicast user plane function 880 is configured to receive the shared data 802 form a data network DN 840 and to forward or to provide or to transmit the shared data 802 to the first and second broadcast/multicast user plane functions 830a, 830b. As another optional feature, broadcast/multicast user plane function 880 comprises a selector 890 and a filter 900. The Broadcast/multicast user plane function 880 may optionally select and/or filter the shared data, for example using one or more downlink classifiers. Filtering and/or selection may be performed in any hierarchical level, and according to different rules.

As another optional feature, the communication system is further configured to use one or more unicast user plane function 910. The unicast user plane function 910 is configured to receive unicast data 801, e.g. data intended for a single UE, from a data network 840 and to forward the shared data 802to the access network. Alternatively or in addition (as shown in FIG. 8) the unicast user plane function 910 may forward unicast data 801 form the access network, 810b, e.g. from a base station 820 of the access network, to the data network 840.

As another optional feature, as shown in FIG. 8, the communication system may be configured to, e.g. simultaneously, serve a single data communication apparatus, e.g. a single UE 850, using one or more broadcast/multicast user plane functions 830a, 830b and one or more unicast user plane functions 910. The serving may optionally be performed via multiple access networks 810a, 810b. Serving the data communication apparatus may comprise providing shared data 802 and/or unicast data 801.

As another optional feature, as shown in FIG. 8, a broadcast/multicast user plane function 830a may be configured to receive a retransmission request 803, which is transmitted by the user equipment 850 via a unicast channel. Therefore, the broadcast/multicast user plane function 830a may comprise a retransmission request receiver 920. Optionally, the retransmission request 803 may be forwarded from the access network 810a, e.g. via or using one of its base stations 820, to the respective broadcast/multicast user plane function 830a. The broadcast/multicast user plane function 830a may be configured to initiate or to start or to provide a retransmission of the shared data, or of a part of the shared data, in response to the retransmission request.

Optionally, as shown in FIG. 8, the broadcast/multicast user plane function 830a may be configured to forward the retransmission request 803 to a data producer or to an application 930. As an example, the data producer/application 930 is part of the data network 840. Hence, the data producer/application may be outside of a core network of the communication system.

As another optional feature, the broadcast/multicast user plane function 830a comprises and event generator 940. The broadcast/multicast user plane function 830a may be configured to generate, e.g. via or using event generator 940, an event in response to the retransmission request. The event generated may be an information, or a flag, or a message, such as “UE having ID x has missed data, retransmission requested”. Such an event may then, optionally, be forwarded or transmitted to other communication system components. or to external applications, e.g. to data producer/application 930.

As additional optional features, the communication system shown in FIG. 8 comprises a broadcast/multicast session management function, BM-SMF 950, which is configured to control one or more broadcast/multicast sessions and an access and mobility management function AMF 960 configured to handle a broadcast configuration and/or a multicast configuration of the access network 810b. Both management functions 950, 960 may influence multiple broadcast/multicast user plane functions, e.g. on different hierarchical levels, and/or multiple access networks.

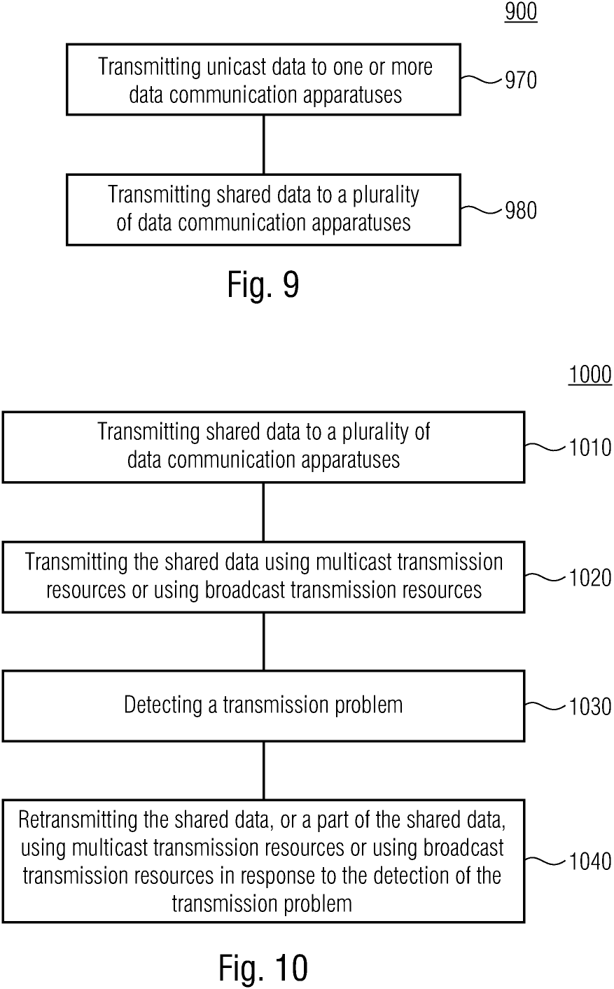

FIG. 9 shows a schematic block diagram of a first method for data communication according to embodiments according to the first aspect of the invention. The method 900 comprises transmitting 970 unicast data to one or more data communication apparatuses, e.g. to one or more UEs and transmitting 980 shared data, e.g. multicast data or broadcast data, to a plurality of data communication apparatuses, e.g. to a plurality of UEs, e.g. within a frame comprising a two-dimensional grid of transmission resource element positions. Furthermore, the unicast data and the shared data are transmitted using a common transmission resource element time-frequency grid, e.g. using a common subcarrier spacing and/or using a common slot length and/or using a common OFDM symbol length.

FIG. 10 shows a schematic block diagram of a first method for data communication according to embodiments according to the second aspect of the invention. The method 1000 comprises transmitting 1010 shared data, e.g. multicast data or broadcast data, to a plurality of data communication apparatuses, e.g. to a plurality of UEs, e.g. within a frame comprising a two-dimensional grid of transmission resource element symbol positions. The method further comprises transmitting 1020 the shared data using multicast transmission resources or using broadcast transmission resources, which are, for example, signaled to be granted for a multicast transmission or for a broadcast transmission and detecting 1030 a transmission problem, e.g. in response to a retransmission request from one or more data communication apparatuses (e.g. a “nack” signaling), or in response to a nonappearance of a confirmation-of-receipt message from one or more data communication devices. In addition, the method comprises retransmitting 1040 the shared data, or a part of the shared data, using multicast transmission resources or using broadcast transmission resources, e.g. “on the multicast channel” or “on the broadcast channel”, in response to the detection of the transmission problem.

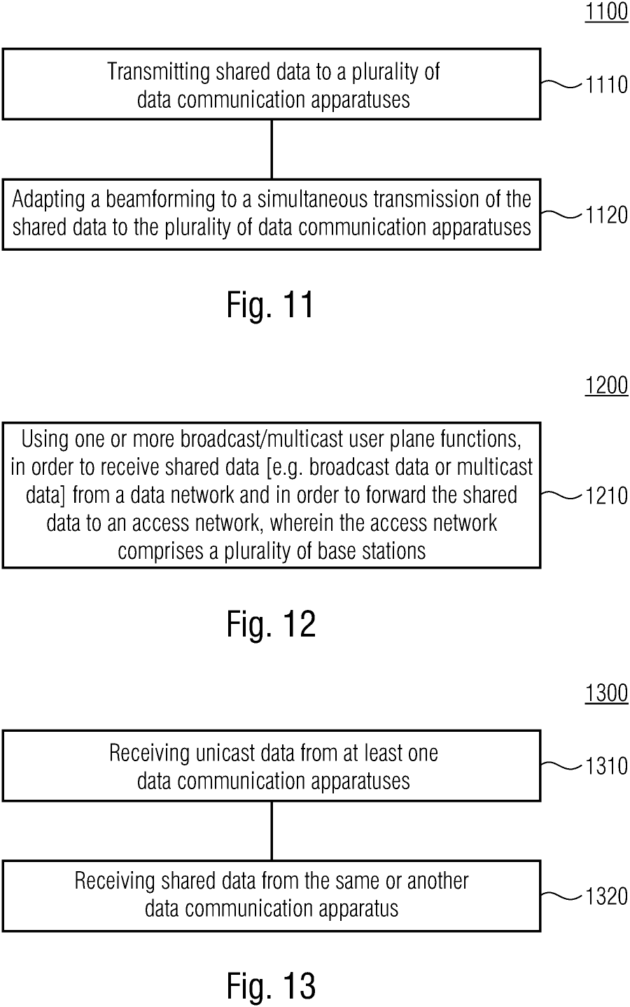

FIG. 11 shows a schematic block diagram of a first method for data communication according to embodiments according to the third aspect of the invention. The method 1100 comprises transmitting 1110 shared data, e.g. multicast data or broadcast data, e.g. simultaneously, to a plurality of data communication apparatuses, e.g. to a plurality of UEs, e.g. within a frame comprising a two-dimensional grid of transmission resource element positions, and, for example, also transmitting unicast data to one or more data communication apparatuses, e.g. to one or more UEs. The method further comprises adapting 1120 a beamforming [which may, for example, be achieved using a simultaneous transmission of a plurality of radio frequency signals via a plurality of antennas, wherein the radio frequency signals may, for example, comprise different amplitudes and/or may be phase shifted with respect to each other, in order to perform the beam forming] to a simultaneous transmission of the shared data to the plurality of data communication apparatuses.

FIG. 12 shows a schematic block diagram of a first method for communication according to embodiments according to the fourth aspect of the invention. The method 1200 comprises using 1210 one or more broadcast/multicast user plane functions, e.g. BM-UPF, in order to receive shared data, e.g. broadcast data or multicast data from a data network and in order to forward the shared data to an access network, wherein the access network comprises a plurality of base stations, e.g. a plurality of base stations “gNB”, which are configured to establish a connection with a plurality of user equipments; e.g. a plurality of “data communication apparatuses” as mentioned above.

FIG. 13 shows a schematic block diagram of a second method for data communication according to embodiments according to the first aspect of the invention. The method 1300 comprises receiving 1310 unicast data from at least one data communication apparatuses, e.g. from one or more base stations. Alternatively or in addition, the method 1300 comprises receiving 1320 shared data, e.g. multicast data or broadcast data, from the same or another data communication apparatus, e.g. from a base station, e.g. gNB, e.g. within a frame comprising a two-dimensional grid of transmission resource element positions. Furthermore, the unicast data and shared data are received using a common transmission resource element, e.g. OFDM subcarrier or e.g. OFDM symbol, time-frequency grid, e.g. OFDM symbol and resource block, e.g. using a common subcarrier spacing and/or using a common slot length and/or using a common OFDM symbol length.

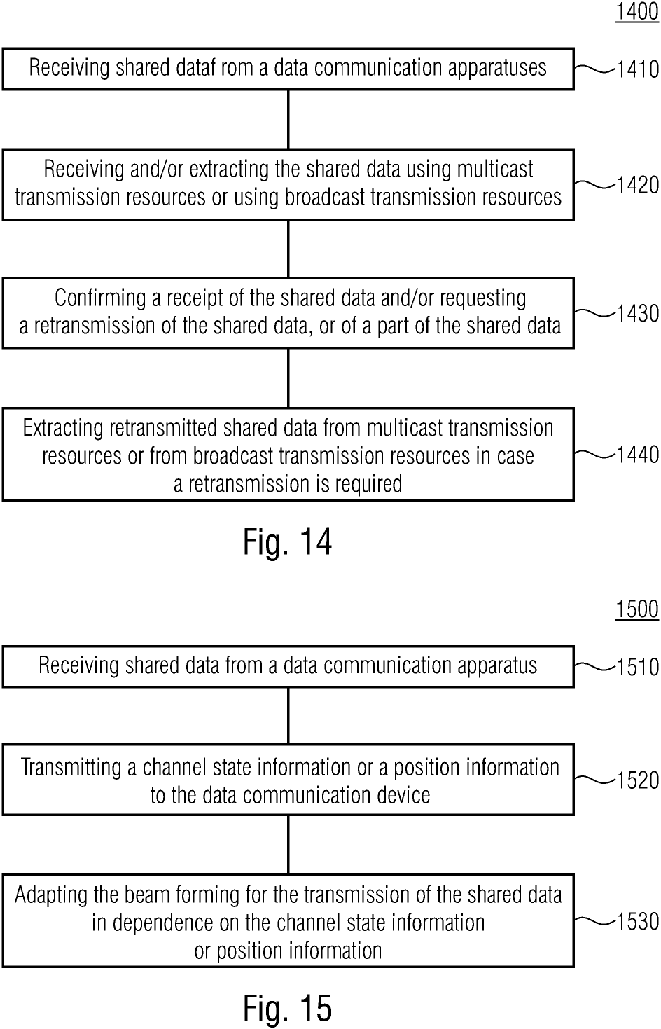

FIG. 14 shows a schematic block diagram of a second method for data communication according to embodiments according to the second aspect of the invention. The method 1400 comprises receiving 1410 shared data, e.g. multicast data or broadcast data, from a data communication apparatuses, e.g. from a base station, gNB, e.g. within a frame comprising a two-dimensional grid of transmission resource element positions. The method 1400 further comprises receiving 1420 and/or extracting the shared data using multicast transmission resources or using broadcast transmission resources, which are, for example, signaled to be granted for a multicast transmission or for a broadcast transmission, and confirming 1430 a receipt of the shared data and/or requesting a retransmission of the shared data, or of a part of the shared data, e.g. via or using a unicast channel or via a low rate unicast channel. Furthermore, the method 1400 comprises extracting 1440 retransmitted shared data from multicast transmission resources or from broadcast transmission resources in case a retransmission is required.

FIG. 15 shows a schematic block diagram of a second method for communication according to embodiments according to the third aspect of the invention. The method 1500 comprises receiving 1510 shared data, e.g. multicast data or broadcast data, from a data communication apparatus, e.g. from a base station, e.g. gNB, e.g. within a frame comprising a two-dimensional grid of transmission resource element positions. The method further comprises transmitting 1520 a channel state information or a position information to the data communication device and adapting 1530 the beam forming for the transmission of the shared data in dependence on the channel state information or position information.

### FURTHER EMBODIMENTS AND ASPECTS

In the following, different inventive embodiments and aspects will be described Also, further embodiments will be defined by the enclosed claims.

It should be noted that any embodiments as defined by the claims can be supplemented by any of the details (features and functionalities) described herein.

Also, the embodiments described herein can be used individually, and can also be supplemented by any of the features included in the claims.

Also, it should be noted that individual aspects described herein can be used individually or in combination. Thus, details can be added to each of said individual aspects without adding details to another one of said aspects.

It should also be noted that the present disclosure describes, explicitly or implicitly, features usable in a data communication apparatus. Thus, any of the features described herein can be used in the context of a data communication apparatus for transmitting data or a data communication apparatus for receiving data or in a communication system.

Moreover, features and functionalities disclosed herein relating to a method can also be used in an apparatus (configured to perform such functionality). Furthermore, any features and functionalities disclosed herein with respect to an apparatus can also be used in a corresponding method. In other words, the methods disclosed herein can optionally be supplemented by any of the features and functionalities described with respect to the apparatuses.

Also, any of the features and functionalities described herein can be implemented in hardware or in software, or using a combination of hardware and software, as will be described in the section “implementation alternatives”.

### 1 Overview

### 1.1 Scope

In the following, aspects of the present invention are described. Embodiments according to the invention comprise apparatuses and methods for 5G NR multicast and broadcast. The following description comprises a chapter for system architecture, addressing and handling of SSC (e.g. Session and Service Continuity), ideas according to aspects of the invention on scheduling modes, e.g. in chapter 2.3.4, and aspects of the inventions about multicast retransmission, e.g. in chapter 2.3.5, ideas according to aspects of the invention of private service devices, e.g. in section 2.3.10, further details, according to aspects of the invention, to system architecture, e.g. including session handling by AMF (e.g. Access and Mobility Management Function) and/or BM-SMF (e.g. Broadcast/Multicast Session Management Function) and/or use of multiple BM-UPFs (e.g. Broadcast/Multicast User Plane Function), e.g. with DL-CL (e.g. Downlink Classifier), sidelink and relay for broadcast/multicast, e.g. broad/multicast according to aspects of the invention, and details for the system architecture according to aspects of the invention, e.g. in chapter 2.3.8.

REFERENCES

| Reference Label | Details |
|---|---|
| [1] | RP-201038, NR Multicast and Broadcast Services, work item description |
| [2] | TS 38.321, Medium Access Control (MAC) protocol specification (Release 16) |
| [3] | TS 38.213, Physical layer procedures for control (Release 16) |
| [4] | TS 38.214, Physical layer procedures for data (Release 16) |
| [5] | TS 23.501, System architecture for the 5G System (5GS) |
| [6] | 3GPP TS 22.185: “Service requirements for V2X services” |
| [7] | 3GPP TS 22.186: “Enhancement of 3GPP support for V2X scenarios; Stage 1” |
| [8] | 3GPP RP-193253: “Study on NR sidelink relay”, OPPO |
| [9] | 3GPP RP-193231: “New WID on NR sidelink enhancement”, LG Electronics |
| [10] | 3GPP TS 22.866: “Enhanced relays for energy efficiency and extensive coverage; Stage 1” |
| [11] | 3GPP TR 23.716: “Study on the Wireless and Wireline Convergence for the 5G system architecture” |
| [12] | 3GPP TS 22.261: “Service requirements for the 5G system” |

ABBREVIATIONS

| | |
|---|---|
| Abbreviation | Meaning |
| ACK | Acknowledgement |
| AMF | Access and Mobility Management Function |
| AN | Access Network |
| CSI-RS | Channel state indication reference signal |
| CQI | Channel Quality Indicator |
| CSI-RS | Channel State Information- Reference Signal |
| DL-CL | Downlink-Classifier |
| DN | Data Network |
| DRX | Discontinuous reception |
| feMBMS | Further enhanced Multimedia Broadcast Multicast Service |
| HARQ | Hybrid Automatic Repeat Request |
| MBMS | Multimedia Broadcast Multicast Service |
| MCCH | Multicast control channel |
| MCR | Minimum Communication Range |
| MTCH | Multicast traffic channel |
| NACK | Negative Acknowledgement |
| NR | New radio |
| PDCCH | Physical Downlink Control Channel |
| PDCP | Packet Data Convergence Protocol |
| PDSCH | Physical Downlink Shared Channel |
| PDU | Protocol Data Unit |
| PMCH | Physical Multicast Channel |
| QoS | Quality of service |
| RLC | Radio link control |
| RNTI | Radio Network Temporary Identifier |
| RRC | Radio resource control |
| SIB | system information block |
| SMF | Session Management Function |
| SSC | Session and Service Continuity |
| TB | Transport block |
| UCI | Uplink control information |
| UL-CL | Uplink Classifier |
| V2X | Vehicle to anything |
| WID | work item description |

### 2 Detailed Description of Aspects of the Invention

### 2.1 Technical Problem Statement

No broadcast/multicast feature support is specified in the first two NR releases of 3GPP, i.e. Rel-15 and Rel-16. Nevertheless, there can for example be important use cases for which broadcast/multicast, e.g. broadcast and/or multicast, could provide substantial improvements, for example regarding system efficiency and/or user experience.

The feature is planned for rel. 17. WID RP-201038, NR Multicast and Broadcast Services, work item description describes the objectives: Group scheduling, Simultaneous operation of all cast modes, Dynamic change between unicast, broadcast and multicast with service continuity, Mobility with service continuity, Improved reliability, Dynamic control of the broadcast/multicast transmission area, Reception of Point to Multipoint transmissions by UEs in RRC_IDLE/ RRC_INACTIVE states.

To facilitate implementation and/or deployment of the feature, the overall implementation impact should be limited, e.g. there may be only a small impact, and/or the UE (e.g. user equipment) complexity minimized or at least kept at a low level. The e.g. various continuity requirements of different applications/services, e.g. applications and/or services for the UE, defined by the modes of Session and Service Continuity (SSC) [5], may or even must also be addressed. To realize these features a new approach is needed:
According to aspects of the invention, the physical layer can for example reuse the Rel-15 numerologies, e.g. physical channels (e.g. PDCCH and/or PDSCH) and/or signals In other words:
Physical layer: according to an aspect, it is optionally possible to limit the scope of this WI to current Rel-15 numerologies, physical channels (PDCCH/PDSCH) and signals.

The following requirements may be fulfilled
Flexible resource allocation between unicast, broadcast and multicast services or respectively between two of these.
Dynamic change between unicast, broadcast and multicast, or respectively between two of these, with service continuity.
Parallel operation of a plurality, e.g. all cast modes
Mobility e.g. with service continuity
Improved reliability, e.g. by support of one or more of the following
   UL feedback
   Beamforming
   Multi-layer transmission
Availability and/or efficient usage e.g. for different device types, e.g. including
   Mobile and/or fixed devices
   Low-power devices (e.g. loT sensors, etc.)
   Energy-aware devices (e.g. smartphones, drones, etc.)
   Embedded devices (e.g. radio receivers, info displays, etc.)
Receive only
Dynamic control of the broadcast/multicast transmission area
Dynamic sharing of radio resources in time and frequency domain between the cast modes for optimal, or efficient, or good, adaptation to corresponding instantaneous and varying bandwidth demands
Support for network slicing
Support for different amounts of user data, e.g. comprising one or more of the following aspects
   High and low bandwidth
   Delay critical and uncritical

### 2.2 Conventional Solutions, Related Patents

The requirements or most of the requirements described in chapter 2.1 are not covered by state of the art broadcast/multicast within 5G up to release 16 or they can be improved by aspects of the present invention.

3GPP specifies an E-UTRAN (LTE) broadcast/multicast mode e.g. to support Multimedia Broadcast/Multicast Service (MBMS) since rel. 8. Rel. 14 introduced e.g. the latest enhancements denoted as further enhanced MBMS (feMBMS) where one, e.g. the most essential change is the extension with new numerologies. On the physical layer MBMS can be associated with a e.g. downlink only physical multicast channel (PMCH), for example mapped on so called MBSFN subframes. MBSFN subframes can for example only support a single antenna port and/or use a e.g. dedicated reference signal pattern. PDSCH (e.g. for unicast) and PMCH (e.g. for multicast) can for example not be mapped on the same OFDM symbol since inter-subcarrier interference could occur. One or even the reason can for example be that OFDM symbols for PMCH can for example either use an extended cyclic or another numerology with lower subcarrier spacing.

Furthermore, or even therefore, PMCH can for example be mapped over the full bandwidth of an OFDM symbol and/or can e.g. only be time multiplexed with PDSCH symbols. Which of the e.g. ten subframes in a frame are used for MBSFN can for example be configured by a bitmap in element subframeAllocation, e.g. in the RRC parameter mbsfn-SubframeConfigList, e.g. in system information block 2 (SIB2). Note that the bitmap can for example be associated with e.g. only 6 subframes in a frame, since for example 4 subframes (0, 4, 5, 9) can for example be reserved for PDSCH, e.g. to receive paging, PBCH and/or synchronization signals. SIB2 can for example also configure the frame period and/or offset, e.g. for MBSFN frames.

PMCH can for example carry a traffic channel, e.g. called multicast traffic channel (MTCH), and/or a control channel, e.g. called multicast control channel (MCCH). Control channel scheduling and/or MBSFN area information can for example be conveyed by SIB13 which can for example be used only for MBSFN. Change of MCCH information can for example only occur at specific radio frames, e.g. establishing a modification period. Within a modification period, the same MCCH information may be transmitted a number of times. When the network changes (e.g. some of) the MCCH information, it can for example notify the UEs about the change, e.g. during a first modification period.

In the next modification period, the network can for example transmit the updated MCCH information. DCI (e.g. Downlink Control Information) format 1C, e.g. with an MBMS specific RNTI, the M-RNTI, can for example notify UEs in RRC_IDLE and/or RRC_CONNECTED about an MCCH information change. The procedure of notification and MCCH update can for example be comparable to system info update, e.g. with notification via the paging channel.

That could mean, the cell capacity taken from PDSCH and given to PMCH can for example not dynamically be changed, rather it can for example be quasi-static. Further, conventional broadcast/multicast can for example essentially receive, only. An uplink can for example only be provided by a parallel unicast, e.g. on MBMS/Unicast-mixed cells.

In summary, flexible resource allocation, dynamic change between cast modes with service continuity, mobility, improved reliability, dynamic sharing of radio resources in time and frequency domain, adaptation to varying bandwidth demands are not or only unsatisfactorily supported, e.g. by state of the art.

### NR Sidelink

The NR sidelink developed in Rel-16 are entirely focused with respect to enhanced V2X services with the provision of unicast, broadcast and groupcast [6], [7] (TS 22.185, TS 22.186). In addition to this, sidelink based relaying with respect to coverage enhancement for wider range of applications is considered in Rel-17 (SI) mainly for UE-to-UE and UE-to-network with main focus on L2/ L3 relay operations [8]. Another WI in Rel-17 is dedicated to the sidelink enhancement, e.g. for the purpose of power saving, enhanced reliability and/or reduced latency applications [9]. Furthermore, requirements for various domains like “inHome”, “SmartFactories”, “SmartCities”, etc. have been identified and explained in TR 22.866 [10]. The inHome domain can extend the residential coverage, e.g. through enhanced relays for example by no additional cables and/or employing a single entry 5G-RG (e.g. residential gateway). A 5G-RG can for example play the role of a UE, e.g. with respect to the 5G core (5GC) and can for example support secure element and/or can for example exchange N1 signaling, e.g. with 5GC. The 5G-RG can for example be either a 5G-BRG (broadband RG) or 5G-CRG (cable RG). The architectural model and concepts of 5G-RG are specified in TS 23.501 and interconnections are elaborated further in [11]. Moreover, the UE-to-Network relay with respect to various traffic scenarios is recorded in the 5G system requirements specification TS 22.261 [13].

However, it should be noted that, optionally, any features, functionalities and details of the conventional solutions may be introduced into any of the embodiment of the present invention, unless they apparently conflict with any of the new features and functionalities.

### 2.3 Solution And/or Approach According to Aspects of the Invention

In the following aspects according to the present invention are described.

Broadcast/multicast, e.g. broadcast and/or multicast, feature support has not been specified for 5G NR in the first two releases 15 and 16. It is now planned to start RAN specification work in the scope of release 17. The objectives are described in work item description (WID) [1].

A central demand formulated in this WID is to minimize the impact on the UE complexity to facilitate implementation and deployment of the feature. That applies e.g. especially to the physical layer so that an e.g. important requirement can for example be to reuse the existing NR numerologies. Moreover, or as consequence, modification and/or enhancements can for example essentially be specified for higher layers and/or system architecture. In other words, 5G broadcast/multicast can for example, or even has to be based on and derived from the unicast air interface.

In the following, aspects according to the present inventions, e.g. a proposal according to the invention is described that can for example turn the unicast into a broadcast/multicast e.g. by fulfilling one or more of the requirements e.g. as listed in chapter 2.1 above.

### 2.3.1 Multicast (Optional Aspect; Details Are Optional)

A concept to use the unicast interface for multicast can for example be based on a new multicast RNTI, for example abbreviated as MC-RNTI. Some or even all UEs capable of multicast can for example obtain the same MC-RNTI, e.g. from the MAC entity in the network. For example, with that, UEs can receive and/or decode e.g. the same multicast data stream. The data can for example be mapped on PDSCH and/or scheduled via PDCCH, e.g. with the suitable downlink DCI format, e.g. or i.e. DCI format 1_0, 1_1 or 1_2, where the fallback DCI format 1_0 can for example be sufficient for most cases.

The MC-RNTI can for example be taken from the reserved values, e.g. FFF3-FFFD ([2], table 7.1-1). One MC-RNTI or multiple MC-RNTIs can for example be assigned. With multiple MC-RNTIs it can for example be possible to separate users into groups. This can for example be beneficial to support network slicing, e.g. so that services with different requirements, e.g. quality of service (QoS), can be bundled, accordingly.

The MC-RNTI can be assigned in any procedure like one or more of the following:
Random access
System information
Dedicated RRC signaling

An embodiment according to the invention comprises, for example, the assignment by the system information. In other words, a solution is the assignment by the system information. Although, multicast can for example be distinguished from broadcast that might need a registration on the network it could for example also allow to collect the MC-RNTIs and/or additional information, e.g. already in IDLE mode for example before and/or or even without registration. In this way a group broadcast can for example be specified as a new mode. The benefit of using system information can for example be that it can be for example most efficient, e.g. since it can for example be itself a broadcast signaling channel.

One or multiple MC-RNTIs can for example be mapped on a suitable system information block (SIB), e.g. SIB2 or a new SIB, e.g. dedicated for broadcast/multicast. The MC-RNTI values can for example be complemented with information, e.g. about the services available in the MBSFN area and/or their association with them.

If a multicast service requires registration to the network, MC-RNTIs can for example also be assigned, e.g. during connection establishment, for example together with the C-RNTI e.g. by the random access procedure.

A corresponding generic information element can for example be specified and/or used for a plurality or even all assignment methods.

The RAN impact for the different layers can for example be
Layer1
   Generation of the scrambling sequence for example for PDSCH, e.g. using MC-RNTI e.g. for the initial value
   Extension of the PDCCH blind decoding procedure e.g. with an additional RNTI
Layer2
   Introduction of the new MC-RNTI e.g. into the specification
   Specification of MC-RNTI values
   Introduction of a new procedure, e.g. for MC-RNTI assignment
Layer3
   Introduction of new information element(s)
   Either Layer 2 or 3: in case of errors in the reception, the UE might request additional redundancy via unicast, e.g. depending on the 5G Quality class indicator (5QI) for example for the QoS flow (e.g. as defined in 3GPP TS 23.501) e.g. used for the broadcast/multicast channel. The additional required redundancy can for example be handled in this case already on the RAN layers, e.g. not on the application layer.

As can be seen, the benefit of this proposal is indeed that can for example fulfill the requirement of minimum or low impact on the UE complexity since existing hardware and algorithms can be reused and for example only procedures need to be adapted.

### 2.3.2 Broadcast (Optional Aspect; Details Are Optional)

### Embodiment 1 (Example)

E.g. like multicast the broadcast can for example be based on the unicast interface, for example with the same principle of mapping broadcast data, e.g. on a PDSCH and/or scheduling with PDCCH. An assignment of an RNTI might not be needed, for example since it can be fixed like the SI-RNTI and/or P-RNTI. For example, since the former can have the fixed values FFFF and FFFE a possible or natural choice for a broadcast RNTI, for example abbreviated as BC-RNTI, could be the value FFFD from the reserved value set FFF3-FFFD. However, any other value out of this set could be fine as well, for example even the unused value 0000. Broadcast with fixed RNTI can for example be received in RX only mode.

### Embodiment 2 (Example)

Another option can be to apply a semi-static approach, e.g. similar to, or even in the same way as in LTE. New SIB(s) can for example be introduced and/or existing SIB(s) extended by e.g. scheduling, periodicity, area and/or other broadcast control information. NR can for example permit more options for scheduling, i.e. one or more of the following:
Time multiplex of PDSCH and/or PMCH slots e.g. in a bandwidth in the same bandwidth part, e.g. by a semi-static time multiplex pattern, e.g. or i.e. same principle as in LTE. This option can for example allow to configure slots with PDSCH only and/or PMCH only.
Frequency multiplex by assigning separate bandwidth parts. That could for example mean, one bandwidth part is PDSCH only, the other PMCH only.
Combination of frequency and time multiplex by mapping PDSCH and/or PMCH on the same bandwidth part and/or combining a semi-static reservation of resource blocks, e.g. in the frequency domain for example with a time multiplex pattern. This option can for example allow to configure slots with PDSCH only, PMCH only and slots with both.

For persons skilled in the art it is clear that any reasonable combination of the options above is possible.

### Embodiment 3 (Example)

A further option can for example be to assign multiple broadcast RNTIs, for example abbreviated as BR-RNTI, via SIB, e.g. so that a registration to the network might not be needed. This e.g. proposal defines a new mode that can be regarded as a group broadcast.

It should be noted that, optionally, the functionalities of the above mentioned Embodiments can be combined.

### 2.3.3 Unicast in Parallel With Broadcast/Multicast (Optional Aspect; Details Are Optional)

Using unicast scheduling via PDCCH can for example enable in an extreme case parallel operation of unicast, broadcast and multicast or of two of these respectively. The benefit of a parallel unicast can for example be that it can be used for signaling and control. For this use case the unicast channel can have a very low bandwidth. It can for example be used for request and/or release of broadcast/multicast, ask for desired service, etc., any signaling from the UE to the gNB and/or vice versa.

Moreover, or as consequence, dynamic changes between unicast, broadcast and multicast can for example be e.g. inherently included and/or service continuity can be maintained. Integration and/or coexistence of UEs, e.g. capable of unicast and/or multicast and/or broadcast and receive-only devices (IoT TV, radio) can be seamless. In addition, the approach according to aspects of the invention can for example generally also be applied to high-tower-high-power architectures (e.g. “HTHP”, as supported by LTE FeMBMS).

The method of dynamic scheduling with RNTI addressing can for example have the e.g. great advantage of the optimal or at least good adaptation to variable bitrate services, for example variable bitrate (VBR) video and/or audio coding. In some examples, even “static” media bit rates do not necessarily hit a single constant value. Corresponding channel capacities can for example be adjusted as needed, e.g. so that channel capacity can be optimally shared and/or exploited with other services e.g. like unicast. Freed capacity can for example be used and marketed for other services. Examples comprise “discount traffic”, application with uncritical delay demands like over-the-air (OTA) updates, infotainment updates, news, weather, stock market, etc. This approach can for example minimize or reduce the waste of resources and at the same time for example increase the efficiency of resource allocation.

### 2.3.4 Scheduling of PMCH (Optional Aspect; Details Are Optional)

Multicast, and possibly broadcast, grants, e.g. conveyed in PDCCH can for example be mapped to coresets in many ways, e.g. or i.e.
together with unicast DCIs, e.g. in the same coreset,
separated from unicast DCIs, e.g. in a dedicated coreset,
coreset 0.

Corset 0 could for example be a logical choice, e.g. since it can contain the PDCCHs for system information, which might closely resemble multicast. Therefore, a embodiment comprises this approach, or for example in other words, It can be therefore the solution.

The following scheduling modes can for example be supported
dynamic
semi-persistent
semi-static

Dynamic and semi-persistent scheduling may, for example, be implemented as in conventional solutions (e.g. as in conventional technology known form unicast). However, any of the additional aspects disclosed herein may optionally also be used in combination with dynamic and semi-persistent scheduling, or in order to improve the conventional dynamic and semi-persistent scheduling.

Dynamic scheduling can be, e.g. most flexible and applied where fast adaption is needed to minimize or reduce the impact on other traffic and/or for optimization of the cell capacity. On the other hand, a higher signaling load on PDCCH might have to be accepted.

Semi-persistent scheduling can be applied, e.g. when the signaling load on PDCCH is an issue. Since radio resources can for example be fixed for some time, e.g. for multicast services with high bandwidth demand of multicast some impact on other traffic might have to be accepted.

The semi-static mode is a new method, where radio resources can be reserved for multicast and/or broadcast.

The reservation can be in one of the following:
1. in frequency domain, only
2. in frequency and time domain

Reservation in frequency domain, e.g. only, might have to be combined with PDCCH, e.g. to signal the opportunities for example in time domain. Reservation in frequency and/or time domain can for example allow e.g. grand less operation. E.g. or I.e. no PDCCH might be needed and/or a UE can for example receive multicast/broadcast, e.g. autonomously.

An embodiment according to the invention comprises the use of the system info to signal multicast/broadcast. In other words a solution to signal multicast/broadcast reservations is, for example, the system info. Another option can for example be RRC signaling but it can be less efficient, e.g. since it can be dedicated to a UE. This method can for example be semi-static, e.g. since it can be changed by system info updates and/or a RRC message.

### 2.3.5 Multicast Retransmission (Optional Aspect; Details Are Optional)

Services like file downloads or over the air (OTA) updates can for example require error-free delivery. To guarantee this the channel coding can be advantageous to be or might have to be robust, e.g. or i.e. the code rate can be low, and/or the receiving device might have to wait for repetitions. So, both the data rate can be suboptimal and/or latency e.g. unnecessarily high. In other words, the available channel capacity might not be exploited and/or inefficiently used.

A retransmission scheme on the multicast channel can for example improve efficiency, e.g. considerable. A solution according to aspects of the invention can be to associate multicast with a low rate unicast channel whose uplink can be used to send ACK/NACKs. For example with that retransmission can be done on all entities which can for example also be responsible for unicast retransmission, e.g. or i.e. PDCP, RLC and/or e.g. even HARQ.

In case of HARQ an additional uplink control information resource (UCI) can for example be advantageous or even necessary to be assigned to distinguish the ACK/NACKs of the multicast and unicast reception.

The advantage of this solution according to embodiments of the invention can for example be that the unicast channel might require e.g. extremely low capacity, for example since it is used for multicast control, e.g. only. Bandwidth adaptation can be applied to multicast, e.g. only, can thus for example facilitate scheduling and can keep the benefit of a one-to-many link, e.g. as much as possible. In other words, even if a few UEs need a retransmission, and most of the UEs not, channel capacity can be efficiently used. A conventional method like redundancy on demand has to adapt the bandwidth on two channels and could for example waste capacity in case of retransmissions to multiple UEs.

### 2.3.6 NR Sidelink (Optional Aspect; Details Are Optional)

NR V2X sidelink specified with release 16 could be a e.g. native solution for broadcast and groupcast, which can for example be comparable with multicast. Its main application could for example be short range broadcast/multicast.

Embodiments according to the present invention can for example support also the relaying single hop and multi-hop scenarios, e.g. as defined in TR 22.866 [10], for example where the Uu, or UP, link can be used between base station and any kind of the gateways, e.g. as defined in [10], for example for different traffic scenarios and/or further the NR sidelink for the connection(s),e .g. between the gateway and at least one UE. Regarding possible implementation details, reference is made, for example, to the section “Conventional Solutions”. In other words, features, functionalities and details described in the section “Conventional Solutions” (or in any other passages describing conventional technology or conventional solutions) may optionally be introduced into embodiments according to the invention.

The gateways in [10] have different names:
5G-Residential Gateway (5G-RG for inHome scenario)
Gateway in SmartFactory traffic scenario
Relay in Metering traffic scenario
Ultimate and intermediate relays in Container traffic scenario
Relay UEs in Public safety traffic scenarios

### 2.3.7 Transmission Modes and Beamforming (Optional Aspect; Details Are Optional)

The simplest transmission mode can for example use a single antenna port, e.g. with omni-directional characteristic. Although codebook precoding might not be supported in 5G NR downlink 2-layer MIMO, e.g. without PMI feedback can for example be supported, e.g. since the layer to antenna port mapping can for example correspond to a unity precoding matrix which can be optimal or advantageous for the cross-polarized antennas which can be advantageous or even mandated for NR. That can for example make 2-layer MIMO suitable for non-unicast.

Beamforming with transparent pre-coding can for example be used for multicast. For beam selection configuration of CSI-RS (e.g. channel state indication reference signal) and/or reporting can for example be needed that can be done, e.g. through a parallel low rate unicast connection.

On gNB side beams toward single UEs can for example be formed. In case that the number of UEs exceeds the maximum number of beams wider beams can for example be formed, e.g. that cover groups of UEs. In principle the beam widths can for example be adapted from narrow for single users, over medium for clustered groups to omni-directional.

It can for example be concluded from the above that DMRS(s) can e.g. be equally well suited for channel estimation than CRS in LTE. This can for example be easy to understand for beamforming towards a single UE. In case of multiple users in a group the UEs could for example receive the same DMRS perturbed by the same channel than the data between gNB and the position of the UE.

### 2.3.8 System Architecture (Optional Aspect; Details Are Optional)

To support multi- and broadcast in the 5G Core Network (5GC), several changes and extensions to existing 5GC components have to be made. In standard Unicast transmission scenarios a UE can for example establish PDU sessions, e.g. with one or multiple User-Plane Function (UPF) instance(s). PDU sessions with UPF instances can for example be managed by the Session Management Function (SMF). Data exchange of user data (ingress and egress) with a data network (DN) of a UE can for example be handled via the assigned UPFs. A UPF can for example be designed as a flexible 5G core entity, which can for example be setup as a standalone component and/or as an Intermediate UPF (I-UPF). I-UPF can for example be a so-called branching point that can be configured to redirect traffic to several downstream UPFs, e.g. by Uplink Classifiers (UL-CL), different data networks and/or similar or other concepts. This is described in the TS 23.501 [5].

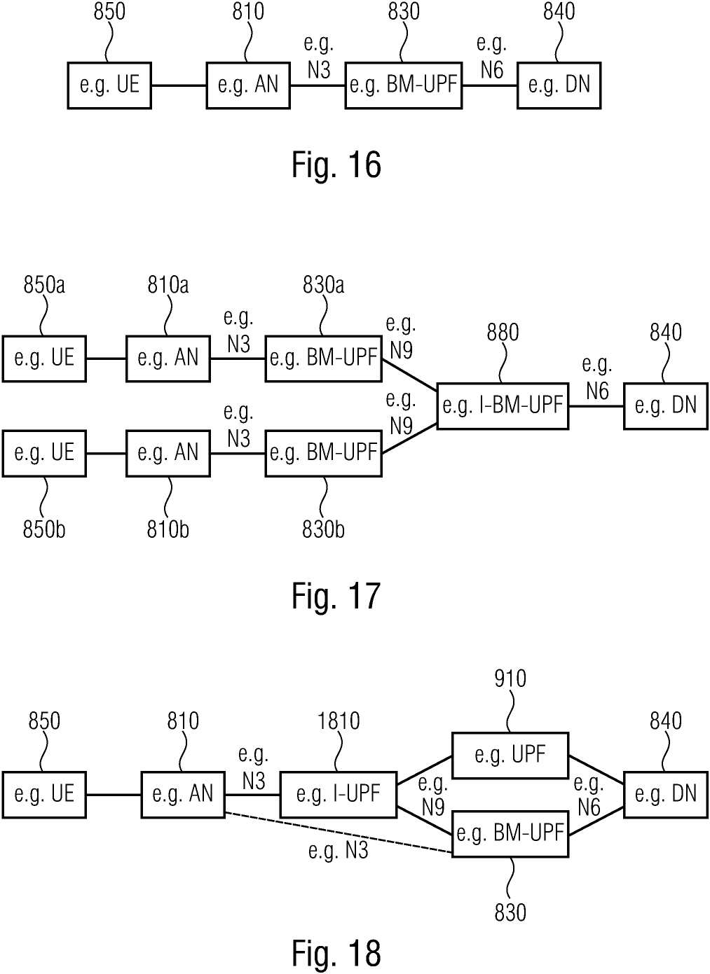

For broad- and multicast communication a new UPF type, e.g. BM-UPF (Broadcast Multicast UPF), may for example enable support, e.g. within the 5GC. FIG. 16 shows an example of User Plane Architecture for Broadcast-Multicast according to an aspect of the invention. FIG. 16 may show a communication system according to embodiments, as explained before. Already existing concepts may for example be easily applicable to and/or with the new BM-UPF 830: A logical multicast or broadcast group can for example be described by a Broadcast Multicast Session (BM-Session) and/or handled by a BM-UPF instance. User data sent to the BM-UPF 830 can for example be broad-and/or multicast to the UEs 850. FIG. 16 shows an example with a simple UPF architecture for Broad- and Multicast support according to aspect according to the invention. The user data, that may for example be broad- and/or multicasted, can be produced in the Data Network (DN) 840. This may be outside of the 5GC network, e.g. a content producer located ‘somewhere’ connected to the internet. The data can be sent to the BM-UPF 830, which is for example responsible for forwarding the data in the 5GC network. The BM-UPF 830 can for example provide the user data to the Access Network (AN) 810, e.g. or i.e. one or multiple base stations. Here it may be broad- and/or multicasted using the described approach, e.g. to the UEs 850.

FIG. 17 shows an example for Branching Point BM-UPFs according to an aspect of the invention. If multiple base stations need to broad- and/or multicast the user data, the BM-UPF 830 can for example be responsible for multiplying and serving all base stations with data. To enable flexibility, the BM-UPF can also be used as an Intermediate-BM-UPF (I-BM-UPF) 880, which for example forwards the user data, e.g. to several BM-UPFs 830a, 830b (see e.g. FIG. 17). Hereby all user data can for example be forwarded or a selection and/or filtering can be done, e.g by Downlink Classifiers (DL-CL), for example analogous to UL-CLs for Unicast UPFs, but e.g. in a reversed order.

FIG. 18 shows an example of User Plane Architecture for UPF and BM-UPF co-existence according to an aspect of the invention. A UE 850 can for example use its unicast connection, e.g. via or using a standard UPF 910, for example to order, re-order and/or reply e.g. to the broad- and/or multicasted user data. In this scenario, a BM-UPF 830 e.g. for broad- and/or multicasting and/or a UPF 910, e.g. for unicast traffic can be advantageous or even be needed. UPFs 910 and BM-UPFs 830 can for example co-exists, e.g. or i.e. a UE 850 can be served by multiple UPFs 910 and/or BM-UPFs 830. FIG. 18 shows an example with a scenario for this co-existence according to an aspect according to the invention. User data can for example be broad- and/or multicasted, e.g. by the BM-UPF 830 to a UE 850 (e.g. dashed N3 link). If the UE 850 needs to (re-)order data, e.g. if it could not receive and/or is now out of broad- and/or multicast coverage, it can for example place a unicast request to the BM-UPF 830. This can be done on a direct way (e.g. dashed N3 link) and/or via an Intermedia-UPF (I-UPF) 1810, which can be configured to handle the UEs unicast traffic and to forward the broad- and/or unicast control requests, e.g. to the related BM-UPFs.

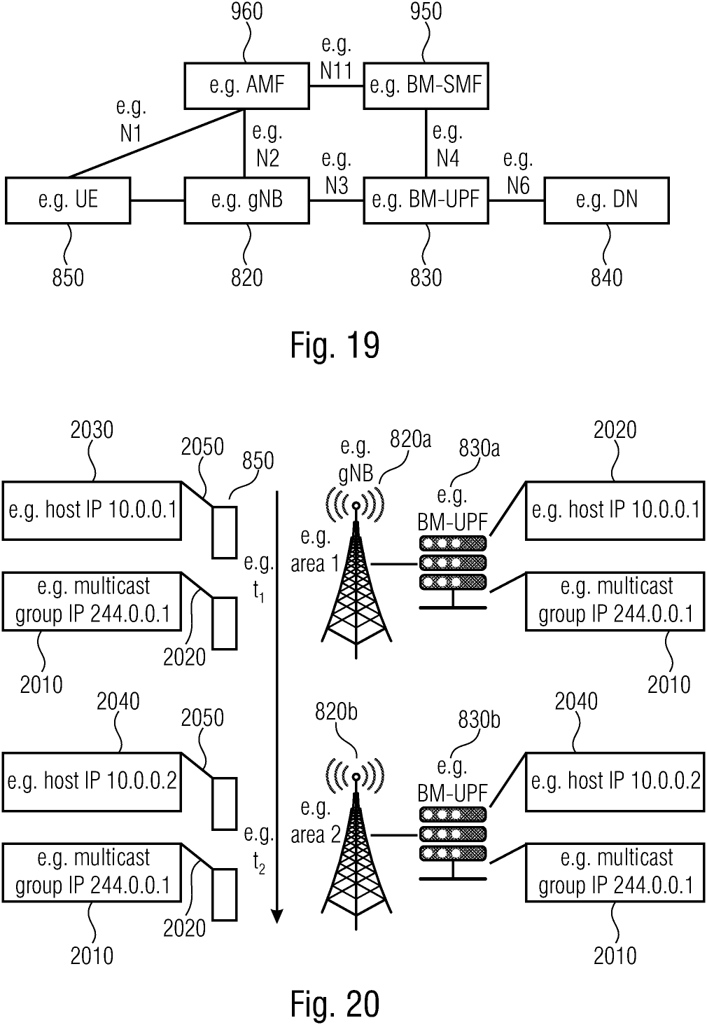

FIG. 19 shows an example of Broadcast Multicast SMF within 5G Core Architecture according to an aspect of the invention. The broad- and/or multicasting of user data can for example be defined by Broad- and/or Multicasting Sessions. A BM-Session can for example represent the transport of a logical data stream, e.g. by an application, for example starting at the producer located in the DN 840, e.g. via or using the BM-UPF 830 to the UE. The BM-Sessions can for example be managed and/or controlled by an extension of the existing Session Management Function (SMF), which can for example be called Broadcast Multicast SMF (BM-SMF) 950. A core function for this purpose can also be newly defined, in other words a newly defined core function for this purpose is also possible.

The existing Access and Mobility Management Function (AMF) 960 may be used and/or extended, e.g. to handle the broad- and/or multicasting configuration of the base stations 820, e.g. or i.e. gNBs, for example according to the e.g. existing BM-Sessions, for example so that the user data, e.g. provided by the related BM-UPFs can for example be sent to the UEs, e.g. via or using the Access Network. FIG. 19 shows an example with the control plane entities and the integration of AMF and BM-SMF with other 5GC entities according to an aspect of the invention.

### 2.3.9 Addressing of Broadcast and Multicast Groups (Optional Aspect; Details Are Optional)

A way, e.g. even the simplest way of transporting the user data to the end devices can comprise using the widely used Internet Protocol (IP), e.g. for user data encapsulation. IP is a stateless protocol, which can e.g. easily be used for unidirectional communication, e.g. like broad- and/or multicast. The described solution can for example work with all common versions of IP, e.g. or i.e. IPv4 and/or IPv6. Other addressing approaches like Information-Centric Networking (ICN) may also be applicable.

The destination address of an IP packet to be broad- and/or multicast can for example either be an IP host or multicast group address. The data network interface receiving the packets can for example be assigned at the BM-UPF, e.g. like it can be done for “standard” unicast-oriented UPFs. As an IP multicast address can for example reach more than one IP endpoint, also setups with multiple BM-UPFs are possible. This can be useful for example, if more than one network segment or BM-UPFs of different operators need to be reached.

### 2.3.10 Handling of Session and Service Continuity (SSC) (Optional Aspect; Details Are Optional)

In the 5G System Architecture [5] three modes are defined for addressing the requirements of different application/services for various continuity belongings. Embodiments according to the invention, for example in other words the solution proposed can meet all three modes, e.g. in different constellations.

FIG. 20 shows an example of SSC scenarios showing a movement from area 1 to area 2 according to an aspect of the invention. SSC Mode 1 can for example be achieved by sending user data to an IP multicast group address 2010. The application on the UE can for example listen for packets, e.g. on this multicast address, which is e.g. preserved on handovers. The BM-Session can for example be broad- and/or multicast, e.g. via or using several gNBs (managed by the AMF), for example so Session and Service continuity on handover and/or location changes may be given. This is demonstrated, for example, by the orange case 2020 in FIG. 20.

SSC Mode 2 and 3 can be achieved by one or more of the following:
Sending user data to an IP host address that changes on handover. This is shown in FIG. 20 by the green case 2050. As an example, in area 1 at a time t₁, a UE may be assigned to a first base station 820a. User data may be sent to IP host address 2030. At a time t₂, the UE may be assigned to a second base station 820b in area 2. User data may then be sent to the new IP host address 2040
Switching from unicast to multi-/broadcast or vice versa. This can be derived from FIG. 20, if one IP interface is removed in one area.

From the application point of view, the destination IP address of received packets can change, for example so that UE application can or even has to adapt its filter settings and/or bindings. Service continuity can be given, as a connection and/or reception may be possible, e.g. at any time.

### 2.3.11 Private Service Devices (Optional Aspect; Details Are Optional)

With fixed configurations it can for example be possible to define and implement devices, which can for example only receive one dedicated broadcast service. It can for example be used for public announcements, emergency warning devices and/or private groups.

### 2.4 Benefits of Aspects of the Invention (Optional)

Embodiments according to the invention, or for example in other words a proposal according to aspects of the invention for NR 5G broadcast and multicast can fulfill and/or exceed the objectives described in [1].

Embodiments according to the invention can be used in apparatuses and systems according to the 3GPP standardization (e.g. in the 5G standardization).

### 2.5 Technical Application Area (Examples)

Embodiments according to the invention may, for example, be used in NR 5G broadcast and/or multicast services. NR 5G broadcast and/or multicast services may, for example, be used in one or more of the following:
Media distribution, V2X applications, public safety, Program Making Special Event (PMSE)
And in case of relaying scenarios: All scenarios (but not limited to) in TR 22.866

### 2.6 Summary of Aspects According to the Invention (Examples)

In the following a summary of (optional) aspects according to the invention is given and or characteristics or achievements of embodiments of the invention are described. Also, an example of a proposed solution, e.g. for the problem to be solved, for example as explained in section 2.1 is described.

Multicast: (one or more or all of the aspects may be used; details are optional)
Introduce a new RNTI for multicast, e.g. MC-RNTI, for example distributed to multiple UEs, e.g. enabling one or more of the following:
   Parallel operation with unicast
   Dynamic change between cast modes with service continuity
   Mobility with service continuity
   Dynamic control of the broadcast/multicast transmission area
   Semi-persistent scheduling
   Resource allocation in frequency and time domain (LTE only time domain)
      Support of network slices
   Beamforming and MIMO possible
Semi-static scheduling (e.g. like LTE) extended with frequency domain multiplexing
Multiple MC-RNTIs
   Can allow group scheduling
For example advantageously conveyed in new system info
   Operation in RRC_IDLE/ RRC_INACTIVE states
   Receive only possible
Parallel unicast for control, MCH for data
   Allows retransmissions on MCH
   Improved reliability

Broadcast: (one or more or all of the aspects may be used; details are optional)
Fixed RNTI, e.g. FFFD (reuse of M-RNTI from LTE), e.g. enabling one or more of the following:
   Parallel operation with unicast
   Dynamic change between cast modes with service continuity
   Mobility with service continuity
   Dynamic control of the broadcast/multicast transmission area
   Semi-persistent scheduling
   Resource allocation in frequency and time domain (LTE only time domain)
      Support of network slices
Operation in RRC_IDLE/ RRC_INACTIVE states
Semi-static scheduling (e.g. like LTE) extended with frequency domain multiplexing

### FINAL REMARKS

Embodiments of the invention have been described according to different aspects. However, it is to be noted, that any features, functionalities and details of any embodiment according to an arbitrary aspect of the invention may be used alone or in combination with any other features, functionalities and details of any embodiment according to another aspect of the invention. A distinct disclosure of features such as the usage of a common transmission resource element time-frequency grid, of a retransmission of the shared data, of the beamforming and of the usage of broadcast/multicast user plane functions is only provided in order to help a person skilled in the art understand the spectrum of the inventive concept.

### IMPLEMENTATION ALTERNATIVES

Although some aspects are described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system con-figured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods de-scribed herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Data communication apparatus for transmitting unicast data to one or more other data communication apparatuses and for transmitting shared data to a plurality of other data communication apparatuses,
wherein the data communication apparatus is configured to transmit unicast data and shared data using a common transmission resource element time-frequency grid; and
wherein the data communication apparatus is configured to inform one or more other data communication apparatuses about an assignment of one or more dedicated identifiers associated with shared data during a connection establishment.

2. Data communication apparatus according to claim 1, wherein the data communication apparatus is configured to transmit a configuration information indicating one or more dedicated identifiers associated with shared data.

3. Data communication apparatus according to claim 1, wherein the data communication apparatus is configured to transmit the configuration information such that the configuration information describes one or more service characteristics of the shared data.

4. Data communication apparatus according to claim 1, wherein the data communication apparatus is configured to inform one or more other data communication apparatuses about an assignment of one or more dedicated identifiers associated with shared data using a dedicated radio resource control signaling.

5. Data communication apparatus according to claim 1, wherein the data communication apparatus is configured to map multicast data onto a physical downlink shared channel and to schedule the transmission of the multicast data using a physical downlink control channel.

6. Data communication apparatus according to claim 1, wherein the data communication apparatus is configured to map broadcast data onto a physical downlink shared channel and to schedule the transmission of the broadcast data using a physical downlink control channel.

7. Data communication apparatus for receiving unicast data from one or more other data communication apparatuses and for receiving shared data from another data communication apparatus,
wherein the data communication apparatus is configured to receive unicast data and shared data using a common transmission resource element time-frequency grid; and
wherein the data communication apparatus is configured to receive and/or evaluate an information about an assignment of one or more dedicated identifiers associated with shared data during a connection establishment.

8. Data communication apparatus according to claim 7, wherein the data communication apparatus is configured to receive and/or evaluate a configuration information indicating one or more dedicated identifiers associated with shared data.

9. Data communication apparatus according to claim 7, wherein the data communication apparatus is configured to receive and/or evaluate the configuration information which describes one or more service characteristics of the shared data.

10. Data communication apparatus according to claim 7, wherein the data communication apparatus is configured to receive and/or evaluate an information about an assignment of one or more dedicated identifiers associated with shared data using a dedicated radio resource control signaling.

11. Data communication apparatus according to claim 7, wherein the data communication apparatus is configured to extract multicast data from a physical downlink shared channel and to extract scheduling information regarding the transmission of the multicast data from a physical downlink control channel.

12. Data communication apparatus according to claim 7, wherein the data communication apparatus is configured to extract broadcast data from a physical downlink shared channel and to extract scheduling information regarding the transmission of the broadcast data from a physical downlink control channel.

13. Method for data communication, the method comprising:
transmitting unicast data to one or more data communication apparatuses; and
transmitting shared data to a plurality of data communication apparatuses; and
wherein the unicast data and the shared data are transmitted using a common transmission resource element time-frequency grid; and
informing one or more other data communication apparatuses about an assignment of one or more dedicated identifiers associated with shared data during a connection establishment.

14. Method for data communication, the method comprising:
receiving unicast data from at least one data communication apparatuses; and/or
receiving shared data from the same or another data communication apparatus; and
wherein the unicast data and shared data are received using a common transmission resource element time-frequency grid; and
receiving and/or evaluating an information about an assignment of one or more dedicated identifiers associated with shared data during a connection establishment.

15. Computer program for performing the method according to claim 13, or claim 14 when the computer program runs on a computer.
